(19) United States
(12) Patent Application Publication
(10) Pub. No.: US 2008/0087762 A1
(43) Pub. Date: Apr. 17, 2008

(54) SYSTEM, METHOD, AND APPARATUS FOR HYBRID DYNAMIC SHAPE BUOYANT, DYNAMIC LIFT-ASSISTED AIR VEHICLE, EMPLOYING AQUATIC-LIKE PROPULSION

(76) Inventors: Richard C. Holloman, Alexandria, VA (US); Timothy M. Peery, Plantation, FL (US)

Correspondence Address: MAXVALUEIP CONSULTING, 11204 ALBERMYRTLE ROAD, POTOMAC, MD, 20854, US

(21) Appl. No.: 11/874,183

(22) Filed: Oct. 17, 2007

Related U.S. Application Data
(63) Continuation-in-part of application No. 11/230,695, filed on Sep. 20, 2005, now abandoned.

(51) Int. Cl. B64B 1/00

(52) U.S. Cl. 244/30

(57) ABSTRACT

A method and system for air flight is shown. The blended lifting body system includes a lift module, a propulsion module, a payload module and a control system. A conventional control system morphs the other modules through variable buoyant lift, internal structures and a flexible exterior, and varies bio-inspired oscillation in the propulsion module in order to facilitate takeoff, flight and landing. The hybrid dynamic/morphing shape buoyant, dynamic lift-assisted (hybrid) air vehicle, employing aquatic-like (e.g. fin) propulsion was discussed, with many variations and examples.

### RELATED APPLICATIONS

This application is the CIP of the co-pending application Ser. No. 11/230,695, filed Sep.-20-20005, with some common inventor, and same assignee.

### FIELD OF THE INVENTION

The present invention relates to the field of hybrid shape-changeable buoyant lift-assisted winged air vehicles capable of both high speed point-to-point flight and extended duration station-keeping flight. By exploiting recent advances in materials and propulsion technology, the invention combines extreme-scale reconfigurations of aerodynamic shape with bio-inspired empennage and fin/fluke oscillation mechanisms to offer unprecedented safety, economy, duration, range and simplicity of variable-vector lift air transportation.

### BACKGROUND OF THE INVENTION

Despite extensive early aviation use of airships and more than a century of aviation advances nearly paralleling the evolution of the automobile, the sky today remains virtually empty of comparable practical, utilitarian public and personal daily use aircraft, especially buoyant lift-assisted air vehicles. Notwithstanding vertical lift and runway-free operational advantages, conventional passenger and cargo airships still suffer prohibitive market entry shortcomings. Conventional fixed and rotary wing aircraft capable of carrying passenger loads comparable to autos remain largely the domain of wealthy businesses or recreational users and of limited daily utility or accessibility for the general public, even for public needs such as law enforcement, search and rescue, disaster response and resource management. The large surface area skin friction and drag of legacy lighter-than-air (LTA) vehicles limit their operational altitude, speed, and aerodynamic load and render them vulnerable to winds and electrical storms especially during takeoff and landing. Lift gas logistics and costs and low/medium altitude atmospheric factors have historically rendered LTA craft impractical, unsafe, and too expensive for airlift of humans in an urban environment or for high altitude payload operations. In short, existing buoyant lift-assisted air vehicles are still too large, cumbersome and slow for most aviation operations, especially for personal travel, and dynamic lift (winged) air vehicles will not soon be found in traditional commuter driveways.

Travelers desiring convenient point-to-point air transportation today remain primarily limited to conventional fixed and rotary winged aircraft variants. Those solutions typically require professional highly trained crewmembers to operate the vehicles on set schedules. The rigid vehicle superstructure is relatively confining, fragile and inherently vulnerable to catastrophic upset, especially during loss of lift or control induced by an engine or pilot incident. In the heyday of airships, however, passengers experienced LTA craft as stable, comfortable, and inherently safe—only too slow, costly, and large, especially for private use.

Private and commercial passengers or cargo payloads for current state-of-the-art air vehicles, including LTA, must typically be transported from point of origin by surface to an airport in order to board. These air vehicles must in turn be stored and operated at locations offering specialized support infrastructure typically some distance away from payload origin, resulting in extra total trip time and operating expense. For high altitude LTA operations, strong winds at medium altitudes are generally an insurmountable barrier to airship transit in a direction of travel opposite to wind direction. Propulsion mechanisms for conventional fixed and rotary wing solutions are typically complex, expensive, noisy, require frequent specialized maintenance, and burn volatile toxic fuels—and LTA propulsion is only marginally better.

Previous attempts to overcome these and other related problems include the following:

U.S. Pat. No. 5,005,783, issued to Taylor.

U.S. Pat. No. 6,848,647, issued to Albrecht.

U.S. Pat. No. 4,012,016, issued to Davenport.

U.S. Pat. No. 3,970,270, issued to Pittet, Jr.

U.S. Pat. No. 7,093,789 issued to Barocela et al.

U.S. Pat. No. 5,194,029 issued to Kinoshita.

U.S. Pat. No. 2,376,780 issued to Kenyon.

U.S. Patent Application No. 2006/0144992, by Jhu and Cowen.

Partial Lift Augmentation class of air vehicles described in the authoritative work by Khoury and Gillett, Airship Technology, p. 478.

Among such prior art attempts to solve the above mentioned problems, none has managed to fully exploit recent advances in materials and processing power that now allow precision bio-inspired empennage and fin/fluke oscillation as a method of propulsion and a synergistic shape-morphing, hybrid buoyant lift-assisted aerodynamic winged air vehicle. This novel craft builds upon and combines in new ways the ingenuity and passion of more than a century of aviation innovations to make possible and practical mankind's quest for nimble, vertical and long endurance point-to-point fuel efficient air transportation that is safe, quiet, economical, easy to use, and environmentally friendly.

### SUMMARY OF THE INVENTION

The purpose of the present invention is to provide a new type of air vehicle accessible to both the general public and for special purpose uses, and system and method thereof, for point-to-point flight requiring minimal ground infrastructure that is safe, economical, quiet, easy to operate, and compatible with current airspace safety regulations. In particular, the present invention relates to intuitive controlled reconfiguration of the best elements of winged air vehicles coupled with variable buoyant lift and bio-inspired empennage and fin/fluke oscillation which enable full-freedom vertical and horizontal flight operations. This modular, hybrid, morphing dynastat air vehicle offers novel aviation capabilities that include exceptional flight upset prevention and recovery characteristics and unique tether operations.

The present invention comprises a lift module, an empennage propulsion module, and a payload module. In most embodiments of the invention, each module comprises mechanisms taught herein for controlled, dynamic changes in shape to optimize vehicle safety and quiet efficiency. Likewise with the exception of small hybrid unmanned and human powered variants of the invention, each module of most embodiments is at least partially lift gas-filled, thereby contributing buoyant lift to the total vehicle. Each comprises internal and external reconfiguration structures as taught herein, and each (with the same exceptions) is generally encapsulated by commercially available strong impermeable flexible skin to enable low-drag effectual morphing buoyant lift-assisted flight. The present invention employs commercially available means (including hook and fastener) for rapid ability to release of the modules from each other, allowing on-ground swapping of various embodiments or subcomponents of each module. Crucial to the present invention's rapid adoption and public success is its readiness for safe operations over residential and high interest areas and its response as taught herein to conventional FAA certified aircraft control system 2-axis and 3-axis yoke and pedal inputs. Designed for safe operation in the most demanding national airspace, including takeoff, landing, changing direction, moving forward, and hovering in the air, this integrated vehicle is largely inspired by buoyant and semi-buoyant aquatic animals swimming in water. Direct feedback pressurized air beam skeletal mechanisms facilitate the dramatic shape transformations needed for progressive stages of variable buoyant lift-assisted flight.

The operator reconfigures, or morphs, the aerodynamic shape of the lift module as described herein during the phases of takeoff, climb, cruise, descent and landing flight by expanding or contracting its buoyant gas volume and dynamic lift shape in conjunction with activating the quiet, safe, efficient propulsion system by means taught below. The lift module's ‘fundamental and novel aerodynamic shape is its customized user requirements-based straight or swing-wing stingray-like blended lifting body that variably expands and elongates to a whale-like shape for full buoyant flight. The lift module comprises commercially available gas impermeable elastomers and films to support variable reconfigurations that accommodate conventional stretching, folding, and rolling mechanisms.

A preferred system of variable dimension interconnected large geodesic cell segments and chambers for use in all three modules are taught herein. The cells expand to hold large volumes of lift gas for vehicle buoyant lift flight when under relaxed structural pressure and augment airframe rigidity and reconfiguration for dynamic flight when compressed. Because positive forces (mechanical, pneumatic and/or aerodynamic) maintain the modules' compressed configuration for dynamic flight, the relaxed state of the expanded module configuration in the absence of such forces is the failsafe mode for flight upset prevention/recovery in the event of engine failure or other emergency loss of control. The conventional alveolar networking of these gas-holding cells is incorporated herein to maintain overall module buoyant lift for hover or controlled down-glide even following accidental or hostile damage to adjacent vehicle substructures.

A novel system of flexible pneumatic skeletal beams, made possible by new high strength light weight materials (effectively spine, spars, and stringers), responds to conventional engine powered isothermal lift gas expansion cylinder forces modeled after high-end isothermal commercial air compressor technology. Resultant compression forces extend or retract the left and right wing extensions, and extend, retract and flatten for aerodynamic advantage the lift and propulsion modules longitudinally. This skeletal frame, connected to the alveolar large cell segments throughout the vehicle modules, comprises the fundamental elements of the closed lifting gas management system means of maintaining in-flight vehicle shape integrity and buoyant lift regulation. The aft end of the lift module skeletal beam receives the motive force but not the oscillation moments of the propulsion module by means of a conventional fluid (air) displacement transmission.

The empennage propulsion module is comprised of a series of articulated variably buoyant lift-gas filled segments, culminating in a rearmost tailfin/fluke, which are conventionally linked together in series and/or symmetrically as the propulsion module spinal structure. A commercially available flexible skin covers the empennage for drag reduction. The propulsion module actuation system employs either legacy or purpose-built devices and principles to convert engine assembly power into novel bio-inspired oscillations of the propulsion module segments and rearmost fluke in fishtail/cetacean and bird-wing fashion to provide dynamic thrust. Propulsion module segment inflation pressure and/or spinal air beam extension and retraction control the longitudinal locus of oscillation of the articulated propulsive segments, inspired by how aquatic animals control tail/fluke shape and spinal stiffness to modulate thrust and cruise dynamics.

The present invention's novel application of conventional isothermal re-pressurization technology to manage large-scale lift module envelope expansion and pressurization of the skeletal/gas storage structure enables harvest of additional lift and propulsion-enhancing heat energy, such as from solar effect, gas pressurization, and operation of the engine. The buoyant force of the expanded lift module lifting gas volume, supplemented by the dynamic thrust and lift generated by the propulsion module, is the primary means of sustaining positive lift force during vehicle takeoff and other primarily neutrally buoyant phases of flight. For transition to dynamic lift phases of flight, the isothermal re-pressurization system pressurizes the skeletal air beam system to stretch the lift module envelope to varying stingray-like wing shapes according to the flight characteristics desired. Resultant form drag reductions allow for increased forward cruise speed and minimize the energy required for the propulsion module to maximize forward thrust and dynamic lift.

Propulsion module morphing comprises a variable spinal stiffness and tail shape control system that manages oscillation frequency and amplitude of the articulated buoyant segments and rearmost caudal fluke for airspeed and maneuverability control, and manages tailfin/fluke sweep and aspect ratio to control laminar flow, boundary layer, wake and vortices. In addition to the conventional flexible skin material covering the articulated propulsion module segments to minimize parasite drag, a novel nacelle shroud in various present invention embodiments encloses the oscillating tail surfaces, further enhancing laminar flow, increasing thrust by containing and directing the compressed tailfin/fluke propulsion output and vortices akin to turbojet principles, and preventing contact between the oscillating propulsion module and nearby objects.

Advantages of the present invention derive principally from hybridization of the best features of airships and airplanes while overcoming their respective disadvantages through morphing and bio-inspired energy efficient propulsion, shape variability and buoyant lift.

Its vertical glide flight enables runway-free takeoff and landing—hence, door-to-door operations minus the historically vast expenses of energy, land use and infrastructure support of runway required by most air vehicles. Because it is airtight, the present invention can also readily operate to and from the surface of bodies of water. Such multi-modal advantage allows trans-mission military or government employment of manned or unmanned air vehicles in maritime, standoff, overhead, and denied airspace operations.

Further advantages of the present invention include the failsafe feature wherein loss of power causes the lift module to revert to its buoyant expanded state, making conventional ballistic parachute recovery systems for small aircraft redundant. This buoyant lift auto-reversion configuration enables novel flight upset prevention and recovery combined with conventional autopilot-controlled/guided gliding flight to a safe and optimal landing site.

Further, extensive published research into the propulsion mechanisms that inspire the present invention demonstrate and explain its advantageous vorticular wingtip wake, propwash, and jetwash in water and air as compared to propellers or turbines, and greatly reduced downwash and related acoustic signatures as compared to helicopter rotors. In addition to enabling quiet outdoor congested urban flight operations, this advantage allows manned and unmanned vehicle operations in enclosed facilities, such as stadiums, auditoriums, and shopping malls.

The present invention can sustain very long loiter and persistent hover time aloft, both in manned and unmanned embodiments, made possible by its very low energy consumption due to buoyant lift. Such station-keeping capability further enables a wide range of tethered, de-tethered, and re-tethered operational advantages, including continuous power up the tether to drive the electric propulsion and payloads (sensors, data and communications relay), and energy harvesting by means of conventional wind turbines, photovoltaic surfaces, and power line inductive power scavenging, and fiber optic high bandwidth transmission up and down the tether. Its lightness and novel low-energy bio-inspired boosted propulsion design also enable practical human-powered variants of the present invention, particularly when combined with advances in solar power and flywheel mechanical battery technology.

Inflation and compression of the present invention allows for easy fold-away reconfiguration for lightweight routine operations from a conventional rooftop or vehicle-top platform deployment, partial folding for overnight parking or securing for inclement weather in a standard two-vehicle garage, and more compact folding for airborne or seaborne deployment and for long term storage and shipping. These same advantages accrue to autonomous and semi-autonomous field deployment of unmanned embodiments of the invention, particular with conventional carbon fiber wound gas cylinders and backpack power supply.

The present invention's novel integration of mostly proven technologies predicts compatibility with conventional autonomous and semi-autonomous control systems that will in turn reduce training and certification requirements and offer disadvantaged populations leap-ahead transportation solutions. Its largely off-the-shelf components and inexpensive materials will make the vehicle conducive to rapid manufacturing and less expensive to produce, certify, acquire and operate than a traditional aircraft. As a result, the inventors are already anticipating rapid after-market conventional and novel technology upgrades for user customization while continuing to seek enhanced range and specific fuel consumption performance superior to comparable solutions in its various scalable embodiments.

The present invention is compatible with nationally and internationally-sponsored conventional dual-use lift gas and alternative non-fossil fuels and technologies to reduce air transportation noise and environmental impact. Requiring minimal logistical support (refueling, maintenance, etc.) infrastructure compared to turbine and propeller aircraft, adoption of the present invention to supplant legacy transportation modes and infrastructure will improve air quality and land use while enabling off-grid transportation autonomy. Larger-scale embodiments of the present invention, as well as multiples of the present invention connected together, could operate over oceanic and sparsely populated airspace in scheduled and linked shipping configurations similar to barges and ships with corresponding commercial transportation savings in crew, navigation, and fuel expenses.

Subsystems of the present invention can be optionally introduced as add-on modular attachment kits for coupling with compatible legacy aircraft to incrementally introduce LTA benefits compared to purpose-built hybrid vehicles such as the present invention embodiments taught herein. These include near vertical liftoff, less restrictive airspace rules for tethered flight, near point-to-point flight at a wide range of altitudes and airspeeds, and short and extremely short takeoff and landing operations. Similarly, basic kit embodiments of the present invention are conducive to distributed manufacturing for licensed production of local market-customized air vehicles.

The present invention overcomes limitations of conventional powered and non-propulsion long endurance aerostatic flight vehicles—e.g. dirigibles, blimps, aerostats, helikites, and balloons—such as wind limits, limited cruise speed, need for launch and recovery infrastructure, and shape and gas management challenges induced by altitude and speed change. The invention thereby enables precision delivery and low-cost air-launch of payloads, replacing imprecise parachute delivery systems for personnel or cargo by trading altitude energy for distance, speed, endurance, maneuverability and long-life reusability.

The present invention overcomes limitations of legacy powered aerodynamic flight vehicles—e.g. helicopters, gliders, and airplanes—such as reliance on airspeed over an airfoil to generate lift and the resultant need for a cleared ground or runway surface. In addition to superior ability to sustain a long duration fixed position over the ground, and reduced vulnerability to catastrophic loss of motive power whether operated as a manned or unmanned vehicle, the invention offers greatly reduced signal and reflective detectability due to its minimal operating noise, heat, and wake, and energy-absorbent construction.

The present invention is not limited in its application to the details of construction and to the arrangements of the components set forth in the following description or illustrated in the following drawings. The invention is capable of other embodiments and of being practiced and carried out in various ways. Therefore, the phraseology and terminology employed herein are for the purpose of description and should not be regarded as limiting. Any equivalent teachings will also be included here.

### BRIEF DESCRIPTION OF THE DRAWINGS

FIG. 1 (a) is a perspective view of a Modular Hybrid Morphing Air Vehicle in nearly fully aerodynamic configuration showing modules according to a preferred embodiment of the present invention

FIG. 1 (b) is a perspective view of the Functional of a Modular Hybrid Morphing Air Vehicle showing relationship of drive and gas management components according to a preferred embodiment of the present invention.

FIG. 2 is a perspective view of a Modular Hybrid Morphing Dynastat Air Vehicle in near-buoyant configuration according to a preferred embodiment of the present invention.

FIG. 3 (a) is a perspective view of a Fluke-Tail Hybrid Morphing Air Vehicle in full-buoyant configuration according to a preferred embodiment of the present invention.

FIG. 3 (b) is a lateral view of a Fluke-Tail Hybrid Morphing Air Vehicle in full-buoyant configuration according to a preferred embodiment of the present invention

FIG. 3 (c) is a top view of a Fluke-Tail Hybrid Morphing Air Vehicle in full-buoyant configuration according to a preferred embodiment of the present invention

FIG. 3 (d) is a side view of a Fluke-Tail Hybrid Morphing Air Vehicle in full-buoyant configuration according to a preferred embodiment of the present invention.

FIG. 4 is a Fluke-Tail Hybrid Morphing Air Vehicle in nearly-full aerodynamic configuration according to a preferred embodiment of the present invention

FIG. 5 (a) is a perspective view of a Fluke-Tail Hybrid Morphing Air Vehicle in full aerodynamic configuration according to a preferred embodiment of the present invention

FIG. 5 (b) is a top view of a Fluke-Tail Hybrid Morphing Air Vehicle in full aerodynamic configuration according to a preferred embodiment of the present invention

FIG. 5 (c) is a front view of a Fluke-Tail Hybrid Morphing Air Vehicle in full aerodynamic configuration according to a preferred embodiment of the present invention

FIG. 5 (d) is a side view of a Fluke-Tail Hybrid Morphing Air Vehicle in full aerodynamic configuration according to a preferred embodiment of the present invention

FIG. 6 (a) is a hybrid Morphing Air Vehicle in Streamlined Full-Buoyant Configuration: a top view of a Hybrid Morphing Air Vehicle in Streamlined Full-Buoyant Configuration according to a preferred embodiment of the present invention.

FIG. 6 (b) is a side view of a Hybrid Morphing Air Vehicle in Streamlined Full-Buoyant Configuration according to a preferred embodiment of the present invention

FIG. 6 (c) is a front view of a Hybrid Morphing Air Vehicle in Streamlined Full-Buoyant Configuration according to a preferred embodiment of the present invention

FIG. 7 (a) is a top view of a Hybrid Morphing Air Vehicle in Streamlined Full-Buoyant Configuration according to a preferred embodiment of the present invention

FIG. 7 (b) is a Side view of a Hybrid Morphing Air Vehicle in Streamlined Full-Buoyant Configuration according to a preferred embodiment of the present invention

FIG. 7 (c) is a Front view of a Hybrid Morphing Air Vehicle in Streamlined Full-Buoyant Configuration according to a preferred embodiment of the present invention

FIG. 8 (a) is a top view of a Hybrid Morphing Air Vehicle in Streamlined Full-Buoyant configuration according to a preferred embodiment of the present invention

FIG. 8 (b) is a Side view of a Hybrid Morphing Air Vehicle in Streamlined Full-Buoyant configuration according to a preferred embodiment of the present invention

FIG. 8 (c) is a Front view of a Hybrid Morphing Air Vehicle in Streamlined Full-Buoyant configuration according to a preferred embodiment of the present invention

FIG. 8 (d) is a Perspective view of a Hybrid Morphing Air Vehicle in Streamlined Full-Buoyant configuration according to a preferred embodiment of the present invention

FIG. 9 (a) is a top view of a Hybrid Morphing Air Vehicle in Streamlined Full-Buoyant Configuration according to a preferred embodiment of the present invention

FIG. 9 (b) is a Side view of a Hybrid Morphing Air Vehicle in Streamlined Full-Buoyant Configuration according to a preferred embodiment of the present invention

FIG. 9 (c) is a Front view of a Hybrid Morphing Air Vehicle in Streamlined Full-Buoyant Configuration according to a preferred embodiment of the present invention

FIG. 9 (d) is a perspective view of a Hybrid Morphing Air Vehicle in Streamlined Full-Buoyant Configuration according to a preferred embodiment of the present invention

FIG. 10 is a Shape-changing buoyant/aerodynamic lift module and tether added to an Unmanned Aerial Vehicle (UAV) according to a preferred embodiment of the present invention

FIG. 11 (a) is a perspective view of a shape-changing buoyant/aerodynamic lift module and tether added to a UAV in a High-speed aerodynamic configuration according to a preferred embodiment of the present invention

FIG. 11 (b) is a perspective view of a shape-changing buoyant/aerodynamic lift module and tether added to a UAV in a slower-speed aerodynamic configuration according to a preferred embodiment of the present invention

FIG. 11 (c) is a perspective view of a shape-changing buoyant/aerodynamic lift module and tether added to a UAV in a Near-buoyant configuration according to a preferred embodiment of the present invention

FIG. 11 (d) is a perspective view of a shape-changing buoyant/aerodynamic lift module and tether added to a UAV in a full-buoyant configuration according to a preferred embodiment of the present invention

FIG. 12 (a) is a side view of a UAV added to a buoyant/lift module tethered to a mast on the ground according to a preferred embodiment of the present invention

FIG. 12 (b) is a Perspective view of a UAV added to a buoyant/lift module tethered to a mast on the ground according to a preferred embodiment of the present invention

FIG. 12 (c) is a Perspective view of a UAV added to a buoyant/lift module tethered to a mast on the ground according to a preferred embodiment of the present invention

FIG. 13 (a) is a full system of a UAV tethered to aerostat which is tethered to a mast on the ground according to a preferred embodiment of the present invention

FIG. 13 (b) is a tether reel mounted to the top of a mast according to a preferred embodiment of the present invention

FIG. 13 (c) is an aerostat detail of a tethered UAV system according to a preferred embodiment of the present invention

FIG. 13 (d) is a UAV detail of a tethered UAV system according to a preferred embodiment of the present invention

FIG. 14 (a) is a Hybrid Morphing buoyant/aerodynamic lift module in a high-fineness ratio, full-buoyant configuration according to a preferred embodiment of the present invention

FIG. 14 (b) is a Hybrid Morphing buoyant/aerodynamic lift module in a near-buoyant configuration according to a preferred embodiment of the present invention

FIG. 14 (c) is a Hybrid Morphing buoyant/aerodynamic lift module in a nearly-full aerodynamic configuration according to a preferred embodiment of the present invention

FIG. 14 (d) is a Hybrid Morphing buoyant/aerodynamic lift module in a full-aerodynamic configuration according to a preferred embodiment of the present invention

FIG. 14 (e) is a Hybrid Morphing buoyant/aerodynamic lift module in a high-speed full aerodynamic configuration according to a preferred embodiment of the present invention

FIG. 15 (a) is a Flexible-Joint Pneumatic Skeletal Beam Diamond Frame in a High-fineness ratio, full-buoyant configuration according to a preferred embodiment of the present invention

FIG. 15 (b) is a Flexible-Joint Pneumatic Skeletal Beam Diamond Frame in a near-buoyant configuration according to a preferred embodiment of the present invention

FIG. 15 (c) is a Flexible-Joint Pneumatic Skeletal Beam Diamond Frame in a Nearly-full aerodynamic according to a preferred embodiment of the present invention

FIG. 15 (d) is a Flexible-Joint Pneumatic Skeletal Beam Diamond Frame in a fully aerodynamic configuration according to a preferred embodiment of the present invention

FIG. 15 (e) is a Flexible-Joint Pneumatic Skeletal Beam Diamond Frame in a high-speed full aerodynamic configuration according to a preferred embodiment of the present invention

FIG. 16 (a) is an isometric view of a Large Caudal Fin Morphing Air Vehicle in nearly-buoyant configuration according to a preferred embodiment of the present invention

FIG. 16 (b) is a front view of a Large Caudal Fin Morphing Air Vehicle in nearly-buoyant configuration according to a preferred embodiment of the present invention

FIG. 16 (c) is a side view of a Large Caudal Fin Morphing Air Vehicle in nearly-buoyant configuration according to a preferred embodiment of the present invention

FIG. 16 (d) is a top view of a Large Caudal Fin Morphing Air Vehicle in nearly-buoyant configuration according to a preferred embodiment of the present invention

FIG. 16 (e) is a tail detail view of a Large Caudal Fin Morphing Air Vehicle in nearly-buoyant configuration according to a preferred embodiment of the present invention

FIG. 17 (a) is an isometric view of a Small Caudal Fin Morphing Air Vehicle in a nearly-buoyant configuration according to a preferred embodiment of the present invention

FIG. 17 (b) is a front view of a Small Caudal Fin Morphing Air Vehicle in a nearly-buoyant configuration according to a preferred embodiment of the present invention

FIG. 17 (c) is a side view of a Small Caudal Fin Morphing Air Vehicle in a nearly-buoyant configuration according to a preferred embodiment of the present invention

FIG. 17 (d) is a top view of a Small Caudal Fin Morphing Air Vehicle in a nearly-buoyant configuration according to a preferred embodiment of the present invention

FIG. 17 (e) is a tail detail of a Small Caudal Fin Morphing Air Vehicle in a nearly-buoyant configuration according to a preferred embodiment of the present invention

FIG. 18 (a) is an isometric view of a Shrouded Caudal Fin Morphing Air Vehicle in nearly-buoyant configuration according to a preferred embodiment of the present invention

FIG. 18 (b) is a front view of a Shrouded Caudal Fin Morphing Air Vehicle in nearly-buoyant configuration according to a preferred embodiment of the present invention

FIG. 18 (c) is a side view of a Shrouded Caudal Fin Morphing Air Vehicle in nearly-buoyant configuration according to a preferred embodiment of the present invention

FIG. 18 (d) is a top view of a Shrouded Caudal Fin Morphing Air Vehicle in nearly-buoyant configuration according to a preferred embodiment of the present invention

FIG. 18 (e) is a detail of the Shrouded Caudal Fin tail according to a preferred embodiment of the present invention

FIG. 19 (a) is a top view of a low amplitude, aft-end Caudal Fin oscillation mode according to a preferred embodiment of the present invention

FIG. 19 (b) is a top view of a mid amplitude full-length Caudal Fin oscillation mode according to a preferred embodiment of the present invention

FIG. 19 (c) is a top view of a high amplitude full-length Caudal Fin oscillation mode according to a preferred embodiment of the present invention

FIG. 19 (d) is an end view of an oscillating Caudal Fin

FIG. 19 (e) is a side view of an oscillating Caudal Fin

FIG. 19 (f) is an isometric view of a low amplitude, aft-end Caudal Fin oscillation mode according to a preferred embodiment of the present invention

FIG. 19 (g) is an isometric view of a low amplitude, aft-end Caudal Fin oscillation mode according to a preferred embodiment of the present invention

FIG. 19 (h) is an isometric view of a low amplitude, aft-end Caudal Fin oscillation mode according to a preferred embodiment of the present invention

FIG. 20 (a) is a top view mechanism detail of a wave-oscillating Fishtail Propulsion Module Drive System according to a preferred embodiment of the present invention

FIG. 20 (b) is a top view of a wave-oscillating Fishtail Propulsion Module Drive System according to a preferred embodiment of the present invention

FIG. 20 (c) is an end view of a wave-oscillating Fishtail Propulsion Module Drive System according to a preferred embodiment of the present invention

FIG. 20 (d) is a side view of a wave-oscillating Fishtail Propulsion Module Drive System according to a preferred embodiment of the present invention

FIG. 21 (a) a Fishtail Propulsion Module Drive System according to a preferred embodiment of the present invention

FIG. 21 (b) is an isometric view of a Fishtail Propulsion Module Drive System according to a preferred embodiment of the present invention

FIG. 21 (c) is an isometric Mechanism detail view of a Fishtail Propulsion Module Drive System according to a preferred embodiment of the present invention

FIG. 21 (d) is an isometric view showing cord attachment points of a Fishtail Propulsion Module Drive System according to a preferred embodiment of the present invention

FIG. 21 (e) is a cord sheath detail view of a Fishtail Propulsion Module Drive System according to a preferred embodiment of the present invention

FIG. 21 (f) is a cord attachment point detail view of a Fishtail Propulsion Module Drive System according to a preferred embodiment of the present invention

FIG. 22 (a) is an isometric view of the down stroke motion of horizontal Fluke in the up position according to a preferred embodiment of the present invention

FIG. 22 (b) is an isometric view of the down stroke motion of horizontal Fluke in the down position according to a preferred embodiment of the present invention

FIG. 22 (c) is an isometric view of the up stroke motion of horizontal Fluke in the down position according to a preferred embodiment of the present invention

FIG. 22 (d) is an isometric view of the up stroke motion of horizontal Fluke in the up position according to a preferred embodiment of the present invention

FIG. 22 (e) is a side view of the down stroke motion of horizontal Fluke in the up position according to a preferred embodiment of the present invention

FIG. 22 (f) is a side view of the down stroke motion of horizontal Fluke in the down position according to a preferred embodiment of the present invention

FIG. 22 (g) is a side view of the up stroke motion of horizontal Fluke in the down position according to a preferred embodiment of the present invention

FIG. 22 (h) is a side view of the up stroke motion of horizontal Fluke in the up position according to a preferred embodiment of the present invention

FIG. 23 (a) is a top view of a shrouded horizontal fluke drive system according to a preferred embodiment of the present invention

FIG. 23 (b) is a side section view of a shrouded horizontal fluke drive system according to a preferred embodiment of the present invention

FIG. 23 (c) is a perspective view of a shrouded horizontal fluke drive system according to a preferred embodiment of the present invention

FIG. 24 (a) is a perspective view of Horizontal Opposing Flukes moving apart according to a preferred embodiment of the present invention

FIG. 24 (b) is a perspective view of Horizontal Opposing Flukes moving together according to a preferred embodiment of the present invention

FIG. 24 (c) is a side view of Horizontal Opposing Flukes moving apart according to a preferred embodiment of the present invention

FIG. 24 (d) is a side view of Horizontal Opposing Flukes moving apart according to a preferred embodiment of the present invention

FIG. 25 (a) is a side view of Horizontal Counter-Directional Flukes according to a preferred embodiment of the present invention

FIG. 25 (b) is a top view of Horizontal Counter-Directional Flukes according to a preferred embodiment of the present invention

FIG. 25 (c) is a perspective view of Horizontal Counter-Directional Flukes according to a preferred embodiment of the present invention

FIG. 26 (a) is a cut-away isometric view of a Double Wall inflated Wing according to a preferred embodiment of the present invention

FIG. 26 (b) is a top view of a Double Wall inflated Wing according to a preferred embodiment of the present invention

FIG. 26 (c) is a front view of a Double Wall inflated Wing according to a preferred embodiment of the present invention

FIG. 26 (d) is a isometric Cutaway view of a Double Wall inflated Wing showing alveolar pressure cells according to a preferred embodiment of the present invention

FIG. 26 (e) is a Cutaway detail view of a Double Wall inflated Wing showing alveolar pressure cells, according to a preferred embodiment of the present invention

FIG. 26 (f) is a Wing cross-section detail view of a Double Wall inflated Wing according to a preferred embodiment of the present invention

FIG. 26 (g) is a Side view of a Double Wall inflated Wing showing alveolar pressure cells according to a preferred embodiment of the present invention

FIG. 27 (a) is a Cutaway isometric detail view of a Double Wall inflated Wing turning inside out to change wingspan, showing internal structure, according to a preferred embodiment of the present invention

FIG. 27 (b) is a Top view of a Double Wall inflated Wing according to a preferred embodiment of the present invention

FIG. 27 (c) is a Front view of a Double Wall inflated Wing according to a preferred embodiment of the present invention

FIG. 27 (d) is a Cutaway isometric view of a Double Wall inflated Wing turning inside out, showing internal structure, according to a preferred embodiment of the present invention

FIG. 27 (e) is a Side view of a Double Wall inflated Wing according to a preferred embodiment of the present invention

FIG. 28 is an end-on perspective view of a type of inflated vacuum insulation according to a preferred embodiment of the present invention

FIG. 29 (a) is a cut-away perspective view of an Isothermal compression cylinder in top dead center position according to a preferred embodiment of the present invention

FIG. 29 (b) is a cut-away perspective view of an Isothermal compression cylinder in middle position according to a preferred embodiment of the present invention

FIG. 29 (c) is a cut-away perspective view of an Isothermal compression cylinder in bottom dead center position according to a preferred embodiment of the present invention.

FIG. 30 is a cut-away perspective view of a Tether Rotary Coupling according to a preferred embodiment of the present invention

FIG. 31 (a) is a Side view with breakout of a Tether Spherical Coupling according to a preferred embodiment of the present invention

FIG. 31 (b) is a full section view of a Tether Spherical Coupling according to a preferred embodiment of the present invention

FIG. 31 (c) is a sectioned isometric view of a Tether Spherical Coupling according to a preferred embodiment of the present invention

FIG. 32 (a) is a perspective view of an Integrated, multi-passage tether tube according to a preferred embodiment of the present invention

FIG. 32 (b) is a perspective view of a Tether with separate streamlining sheath and wires and fibers in tube according to a preferred embodiment of the present invention

FIG. 32 (c) is a perspective view of a Tether with separate streamlining sheath and wires and fibers in sheath according to a preferred embodiment of the present invention

FIG. 33 is a perspective view of a Tether with a buoyant/aerodynamic balloon support according to a preferred embodiment of the present invention

FIG. 34 (a) is an isometric view of a Fully retracted mast, according to a preferred embodiment of the present invention

FIG. 34 (b) is an isometric view of a Partially extended Inflated mast, according to a preferred embodiment of the present invention

FIG. 34 (c) is an isometric view of a Mostly extended Inflated mast, according to a preferred embodiment of the present invention

FIG. 34 (d) is an isometric view of a Fully extended Inflated mast, according to a preferred embodiment of the present invention

FIG. 34 (e) is a side section view of a Fully retracted Inflated mast, according to a preferred embodiment of the present invention

FIG. 34 (f) is a side section view of a Partially extended Inflated mast, according to a preferred embodiment of the present invention

FIG. 34 (g) is a side section view of a Mostly extended Inflated mast, according to a preferred embodiment of the present invention

FIG. 34 (h) is a side section view of a Fully extended Inflated mast, according to a preferred embodiment of the present invention

FIG. 35 (a) is an isometric view of an extended gripper, according to a preferred embodiment of the present invention

FIG. 35 (b) is an isometric view of a gripper beginning to curve, according to a preferred embodiment of the present invention

FIG. 35 (c) is an isometric view of a gripper curved more, according to a preferred embodiment of the present invention

FIG. 35 (d) is an isometric view of an almost fully curved gripper, according to a preferred embodiment of the present invention

FIG. 35 (e) is an isometric view of a fully curved grippers, according to a preferred embodiment of the present invention

FIG. 35 (f) is an isometric view of twin opposing grippers, according to a preferred embodiment of the present invention

FIG. 35 (g) is an isometric view of Gripper details, according to a preferred embodiment of the present invention

FIG. 36 (a) is a front view of a Modular Hybrid Morphing Air Vehicle with guided, tethered gripper pendant according to a preferred embodiment of the present invention

FIG. 36 (b) is a perspective view of a Modular Hybrid Morphing Air Vehicle latching onto power line with guided, tethered gripper pendant, according to a preferred embodiment of the present invention

FIG. 36 (c) is a side view of a Modular Hybrid Morphing Air Vehicle with guided, tethered gripper pendant according to a preferred embodiment of the present invention

FIG. 36 (d) is a detail side view of a guided, tethered gripper pendant according to a preferred embodiment of the present invention

### DETAILED DESCRIPTION OF THE EMBODIMENTS

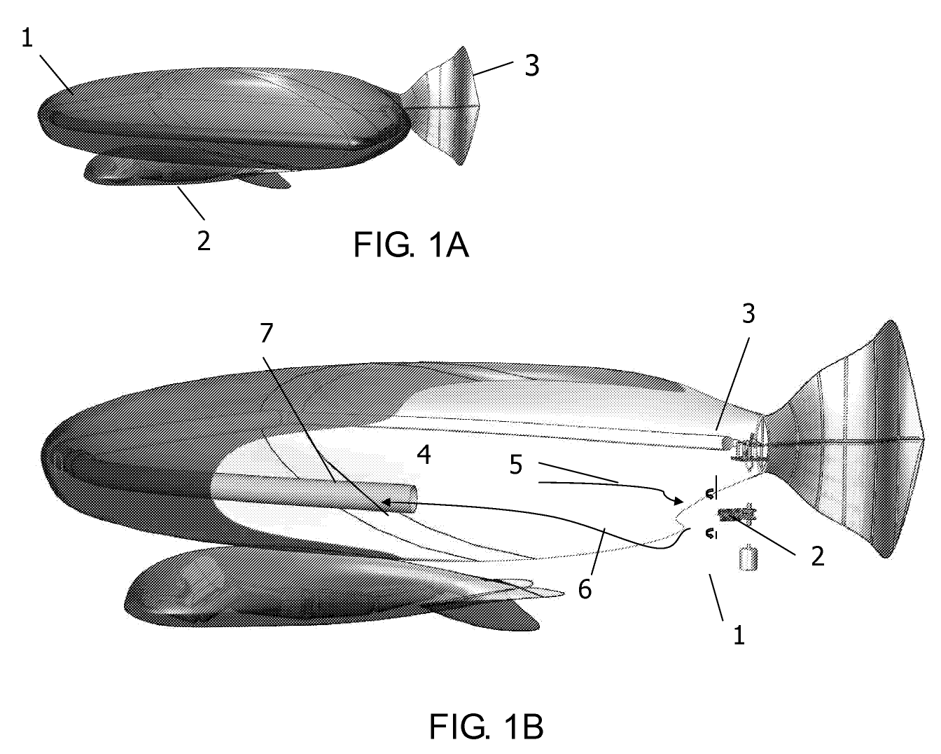

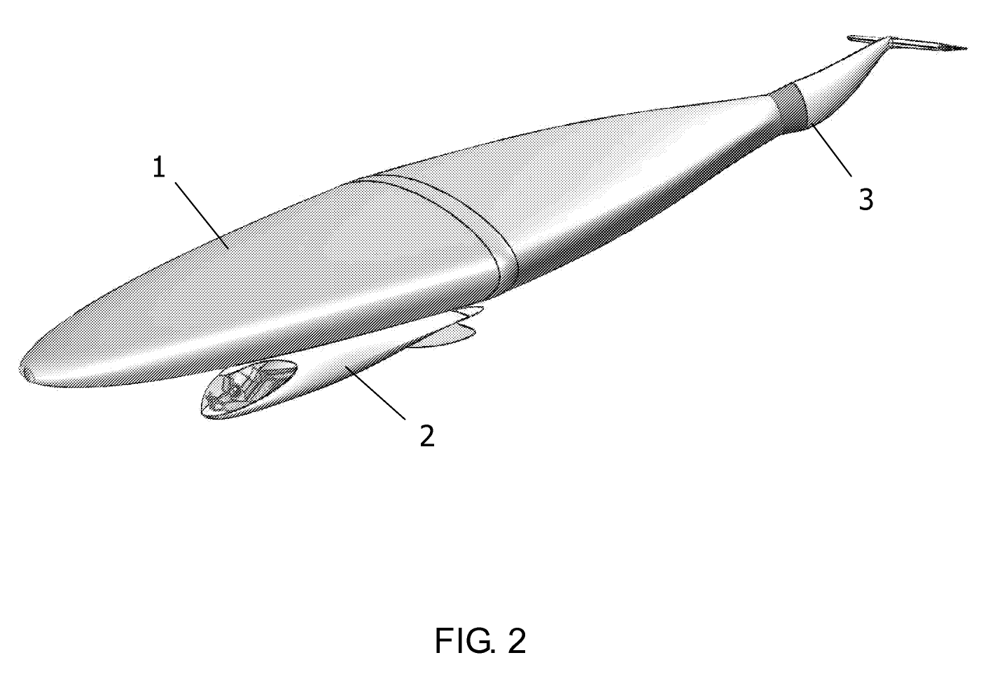

An important feature illustrated by nearly all the drawings of the present invention, in particular FIGS. 1a, 1b, and 2 is the vehicle's modularity using conventional means of universal interoperable attachment and detachment of the various components—useful for flexibility in operations, ease in upgrades, and simplicity in maintenance. Not only are variants of the three primary modules interchangeable according to user preferences, but components of the modules are also highly variable in design and function for combination with conventional off the shelf systems.

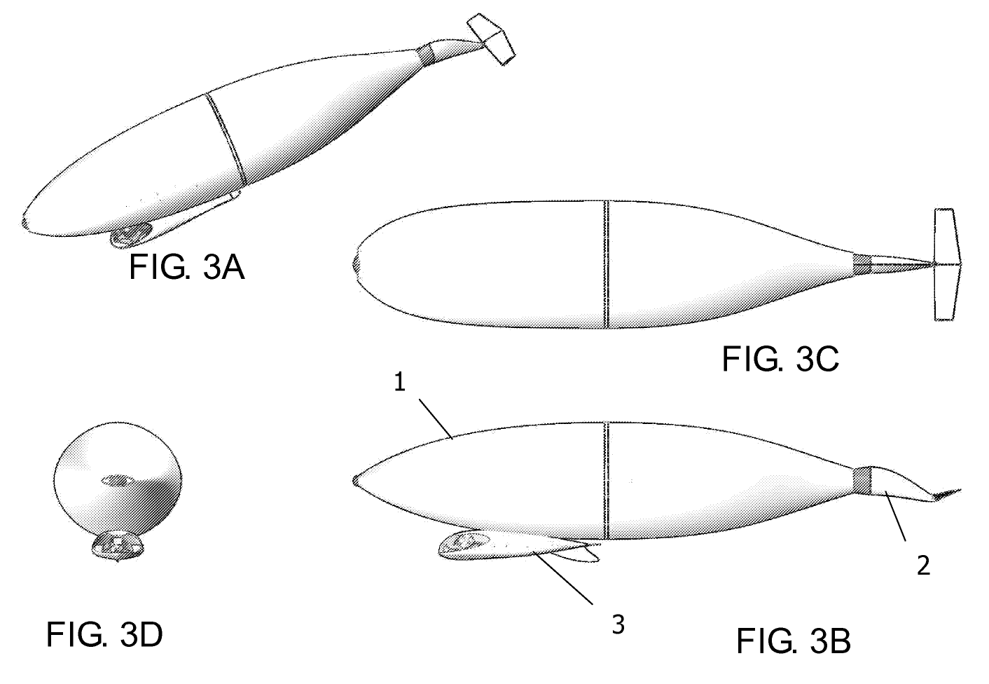

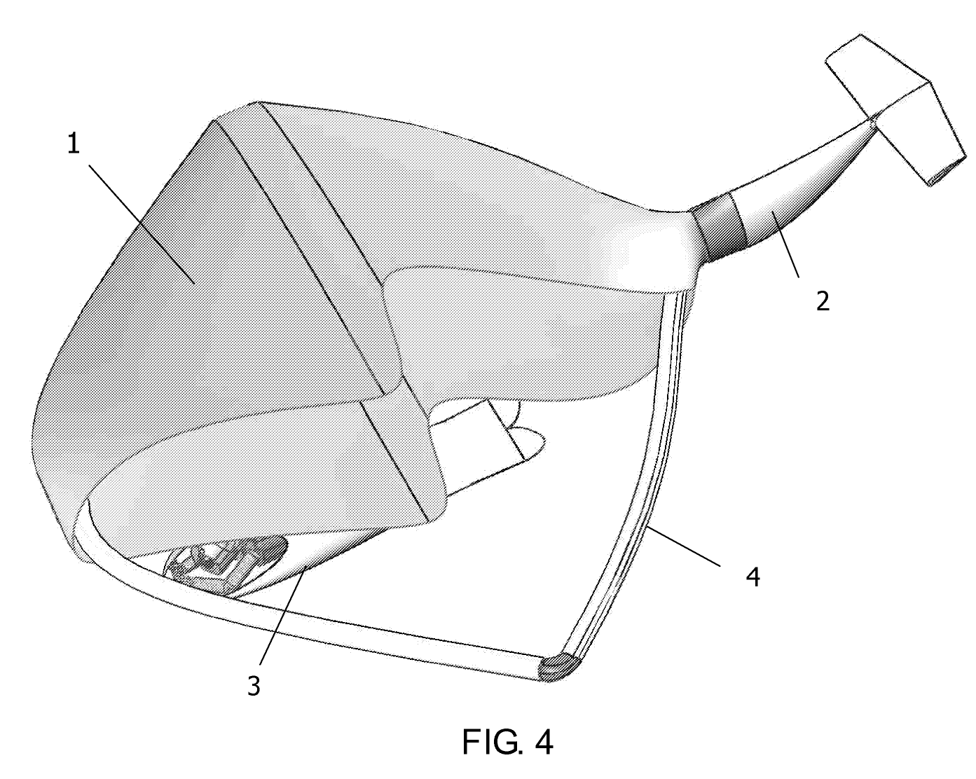

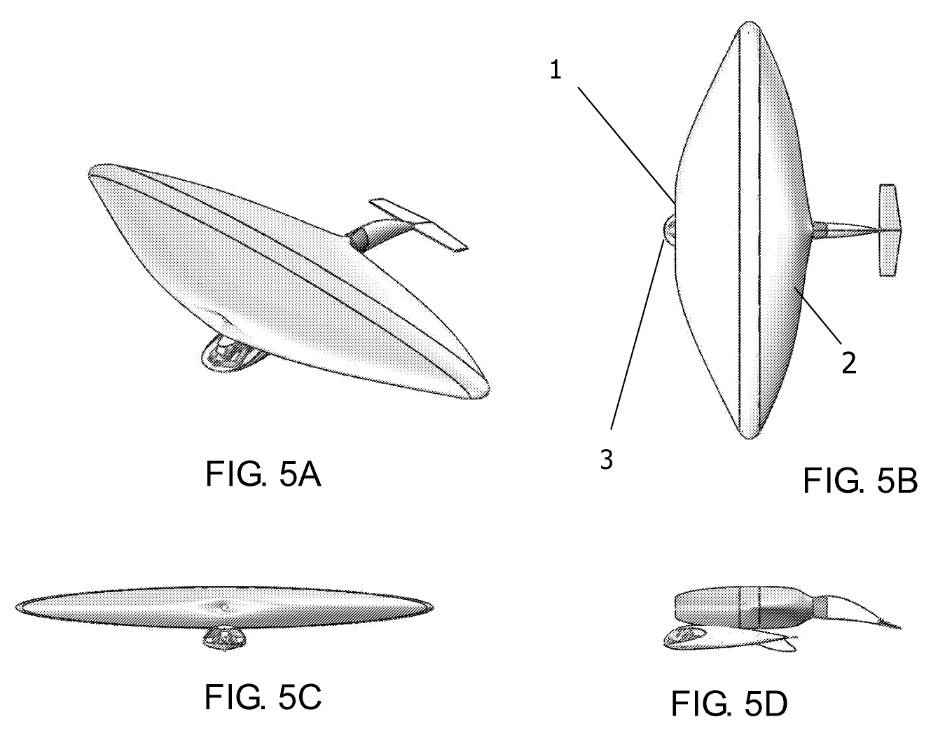

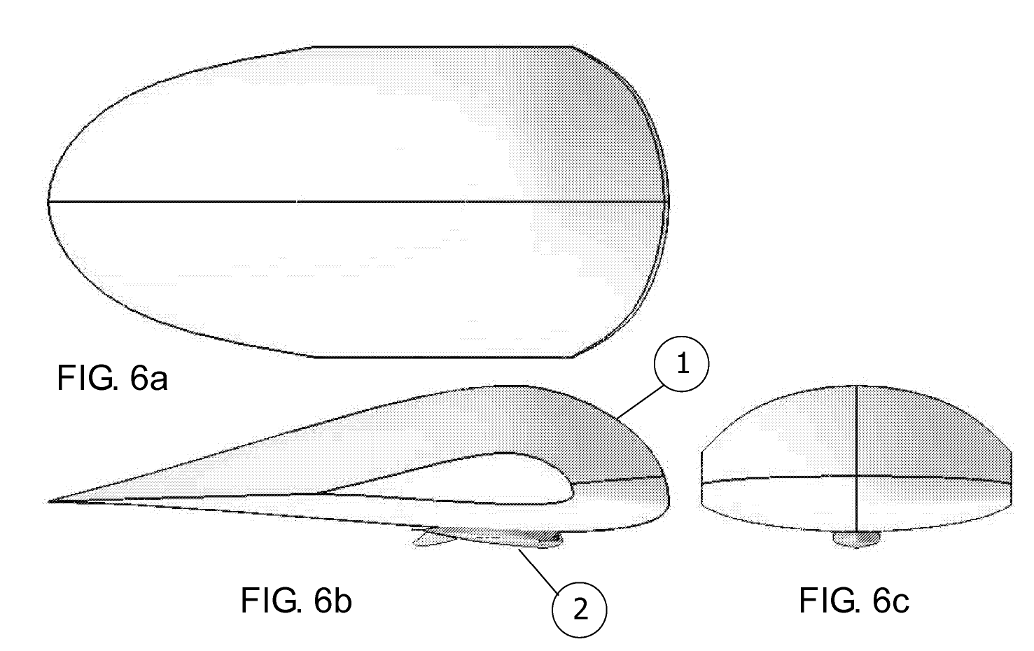

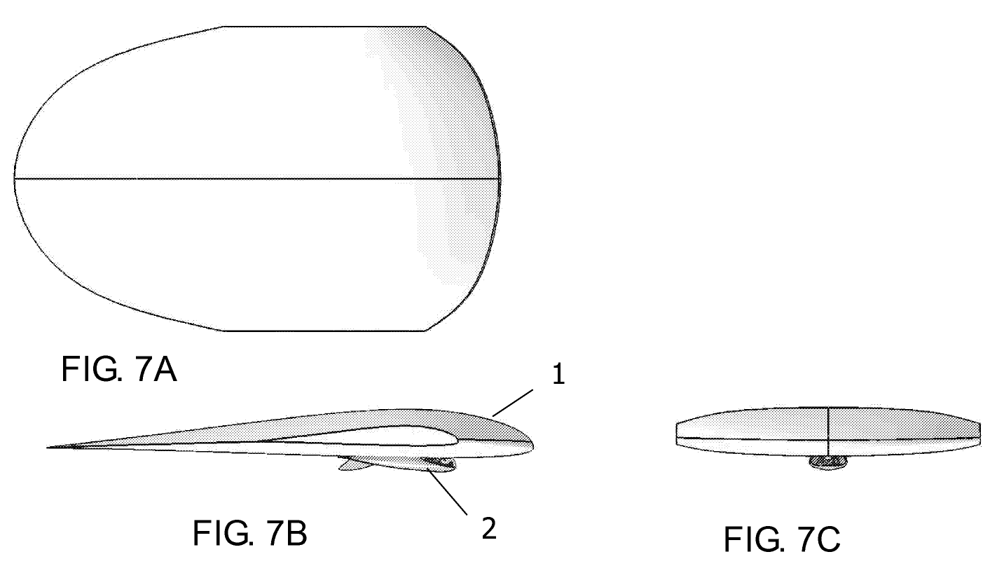

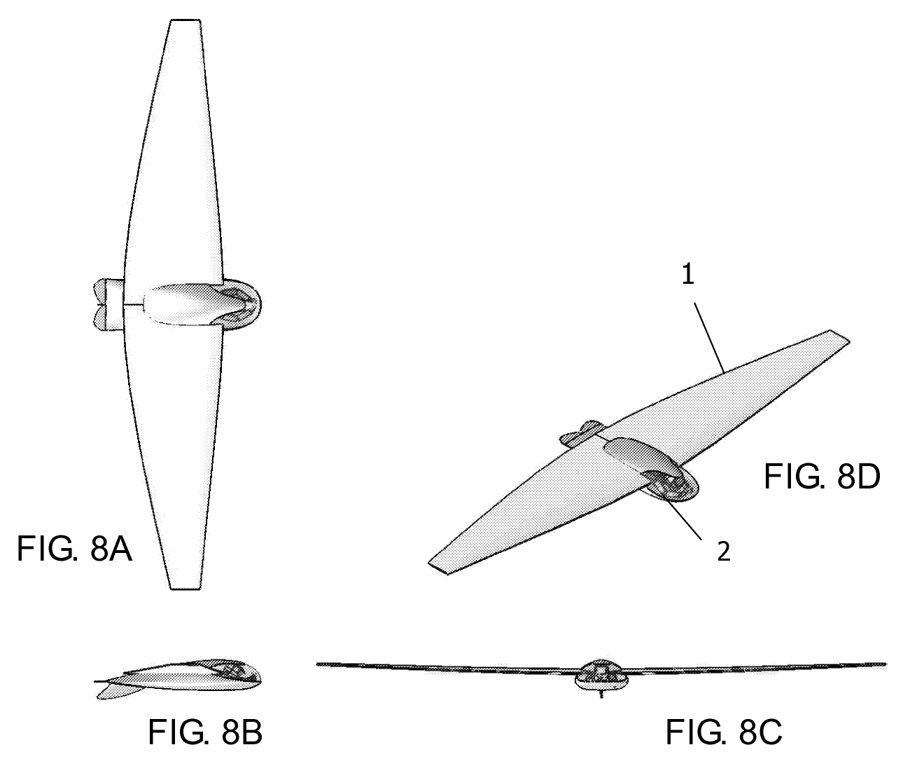

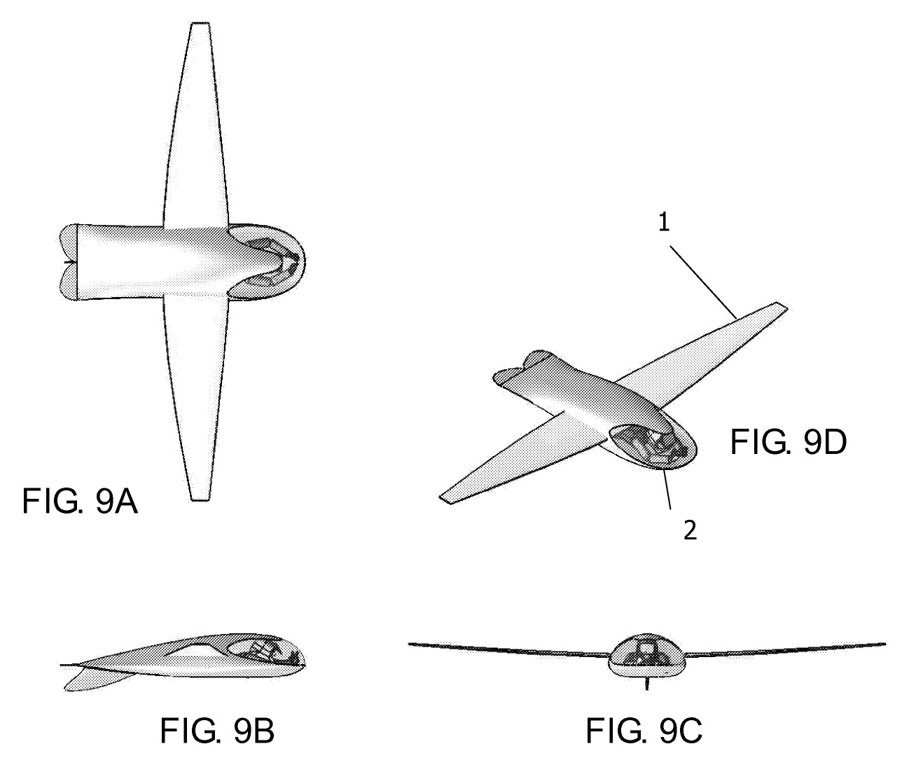

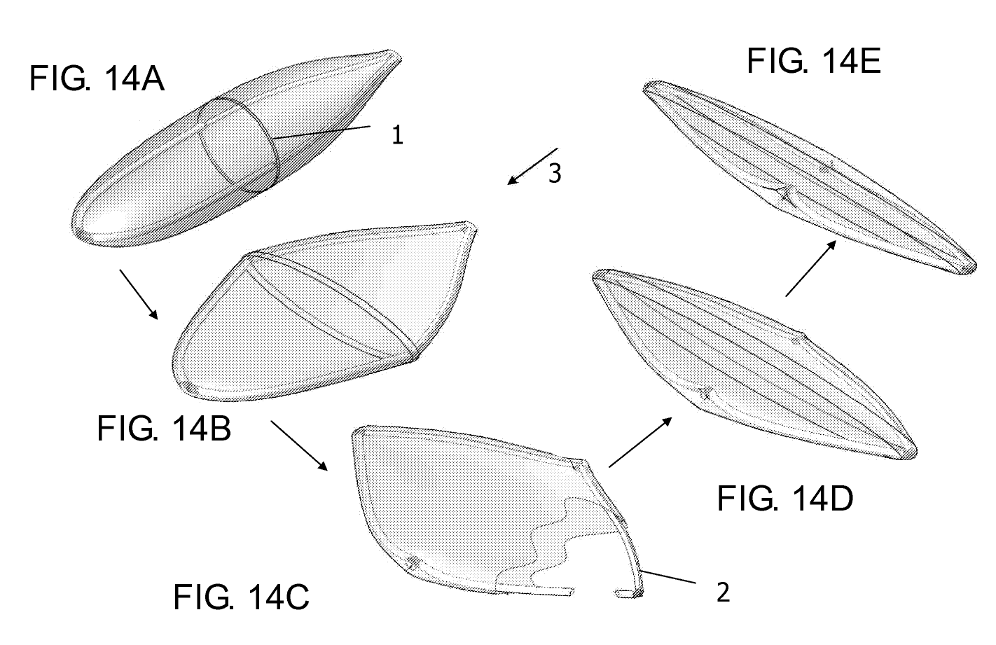

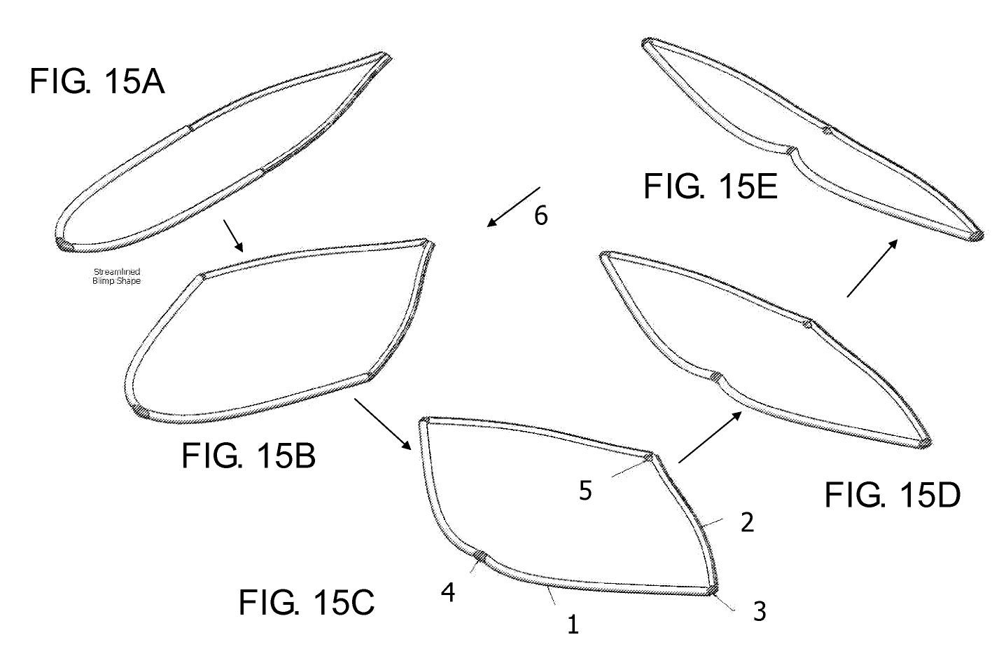

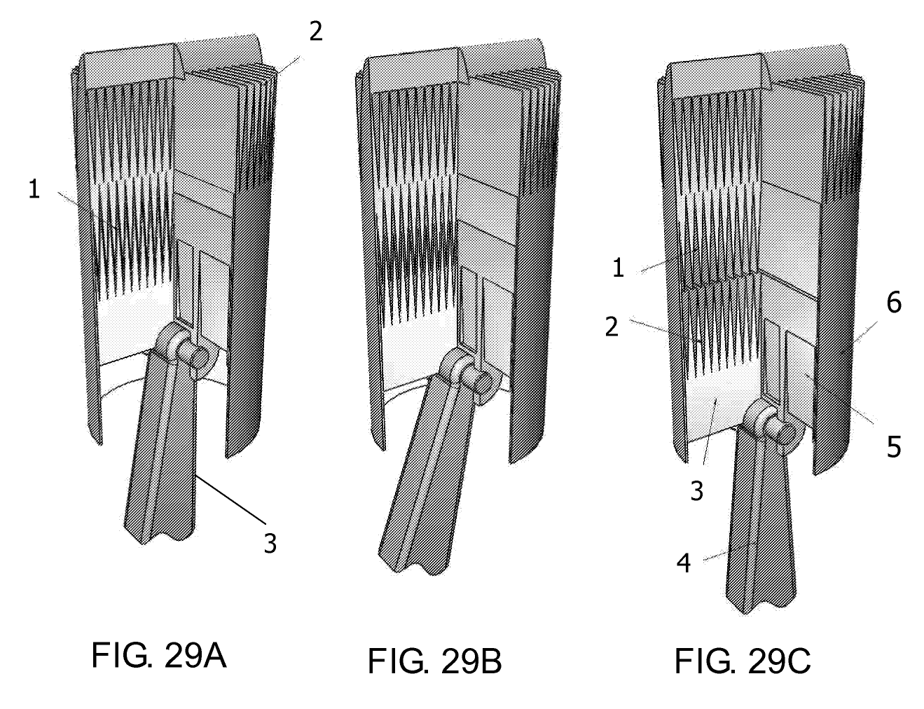

The morphing lift module (FIGS. 3-11) comprises a pneumatically deployable flexible air beam skeletal system (see FIGS. 14, 15) that controls the infinitely variable deployment, redeployment, dimensions and rigidity of the module's left and right wing segments (FIGS. 5, 8, and 9) and central body expansion envelope (FIGS. 6, 7). When configured to favor dynamic flight (FIGS. 8,9), the air beams (FIGS. 15a-e) force the core diamond profile (FIGS. 14b-c) of the lift module to extend laterally into left and right blended wings in conventional inflatable wing fashion (FIGS. 4, 5, 8, 9) by means of its envelope stretching conformably around these pneumatic beams. These beams expand, contract, extend, and retract according to lift gas and air pressure changes generated by a novel application of a conventional isothermal re-pressurization system (FIGS. 29a-c), conventionally clutched or declutched by the conventional engine control system. In-flight two-axis roll and pitch control is effected primarily by conventional simultaneous or differential servo-actuated warping of the lift module wing trailing edge shape in conventional inflated delta wing fashion.

The lift module comprises shape change (FIGS. 14a-e) from whale-like high fineness ratio, high volume buoyant state, to thinner greater span for intermediate lift, partial buoyant state, and thence to wider stingray-like wingspan, thin, full aerodynamic lift state, while maintaining sufficient stiffness in all stages to support load and maintain shape. Enabled by using an arrangement of elastic skin and internal frame (FIGS. 15a-e) built of segments of pressurized rigid tubes (air beams), its elastomer-skin knees may be pressurized to induce a change in angle of each joint and may be single- or double-acting. Said elastomer external skin may be inflated with buoyant gas and shaped by the internal frame.

A preferred embodiment of said lift module is the diamond configuration (FIGS. 14-15), wherein four spar segments, two for the leading-edge spars which may be rounded, optionally asymmetrically, for aerodynamic performance. The left and right, corner knee joints are pressurized to chance toward wider shape, or may be double-acting. The front and rear knee joints may be pressurized to return the craft to long configuration, or may be pressurized to assist the change to wide-span, or may be double-acting. Once the maximum wingspan is reached, said rear knee joint can flex in opposite direction causing wings to fold back so as to make a compact package approximately one-half of module full length. Training-edge spars that are slightly shorter than leading-edge spars could facilitate this.

Rather than discrete knees, said frame elements can be constructed with zones that respond to increased pressure with more or less curvature, twisting or length by variations of local tube diameter. Other options include varying circumferential location of longitudinal reinforcing fibers, (all on one side giving maximum curvature to pressure response, split between one and four o'clock: less response, twelve and six o'clock: no curvature response but flexible in lateral direction; distributed around circumference: no curvature response and stiff), circumferential winding which allows bending and/or elongation but can take more pressure; unidirectional helical winding which creates twist response; bidirectional helical winding which at higher-than-critical (48°) helix angle causes shortening response until close to critical, and at lower-than-critical helix angle causes lengthening response until close to critical. Neutral (minimally-pressurized) tubes may also have molded-in curvature.

Said module can be strapped to humans person(s) with harness or attached to a personal pod (FIGS. 8a-d) for safety, sport or transportation; without propulsion as in hang-gliding, or as in sailing, whether tethered to stationary, base using wind and/or thermal currents for lift, or tethered to an aerostat, towed with winch or swing arm or behind a boat or other vehicle, or as in jumping from plane or other high place; or serving the function of a parachute. Module may be provided with propulsion and/or directional control for powered “parasailing”, extreme free-flying or tethered sport flying.

A suit (FIGS. 1a and b) for streamlining and enhanced directional control, which may be worn by said person(s) and may use bulk flexing or added control surfaces, and may use inflating chambers to fill space and shape skin as desired to reduce aerodynamic drag, add lift and directional control. Adjusting pressure in individual chambers would aid person in maintaining position with minimal effort, and flexing to provide control. Elastomer foam or other means may used to fill the space between the body and skin of desired shape. Said suit may also be used for skydiving, hang-gliding, cycling or other sports or activities. Person pods may be designed to carry one or more people, who may be prone for minimum cross-section and drag or supine for comfort.

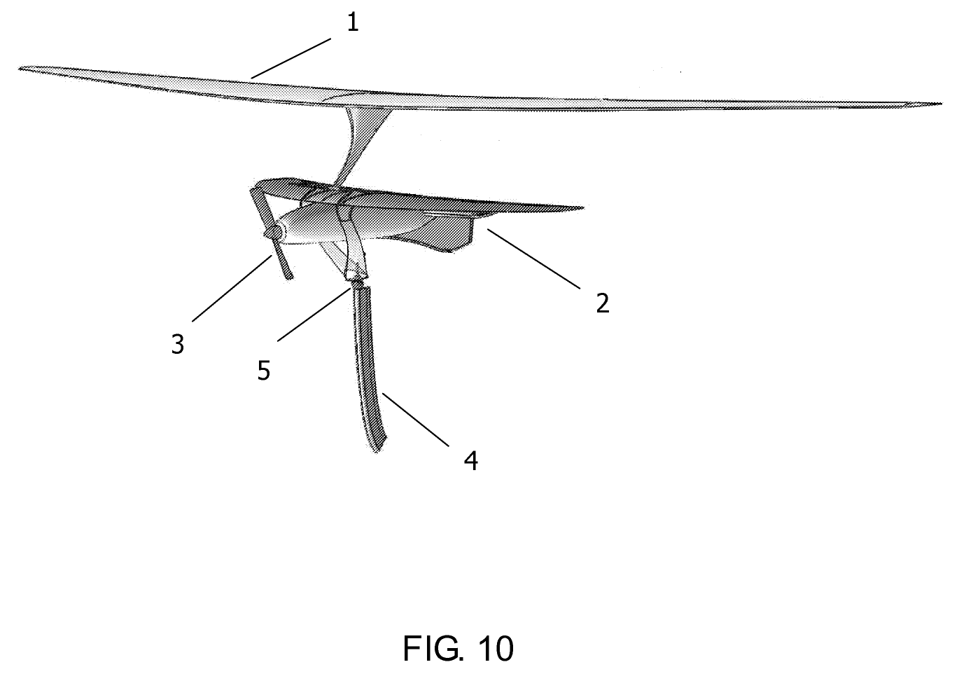

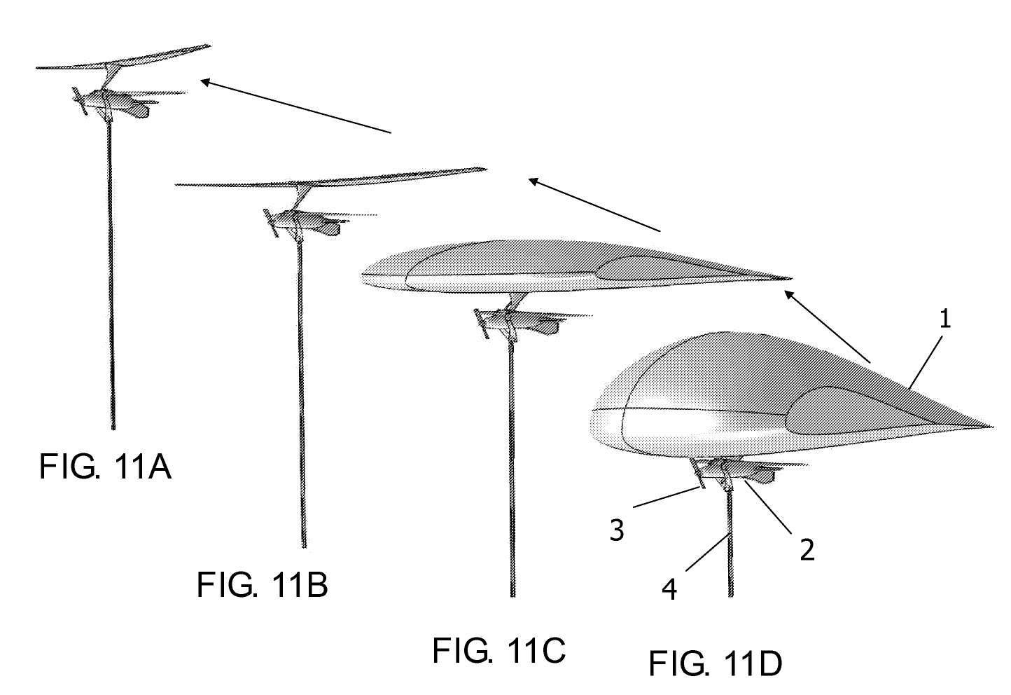

The lift module, inflated with buoyant gas, changes shape and volume so as to provide buoyant lift roughly equal to the gross vehicle weight, including any payload, while minimizing frontal area and drag, during vertical takeoff and landing, stationary or near-stationary hovering, or emergency situations. Said module, scaled appropriately, can be mounted to existing heavier-than-air craft (FIGS. 10 and 11), including unmanned aerial vehicle, ultralight aircraft, glider, general aviation or other aircraft. Such hybrid vehicles can provide superior solutions for many aerial platform requirements by operating on a tether.

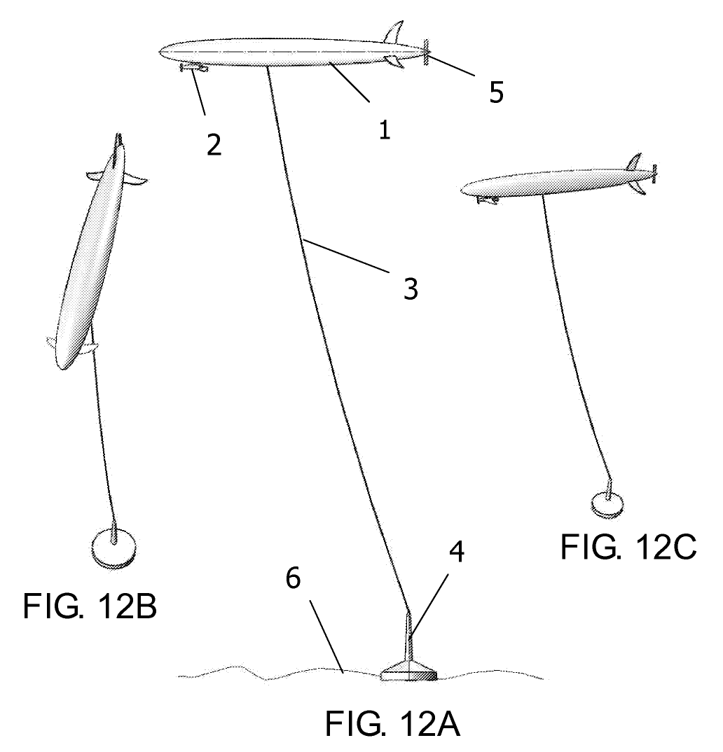

Said tether (FIGS. 10-13, 30-33) may comprise a physical tensile connection of air vehicle to base unit which may be mounted or situated on a ground, marine or air vehicle (which may be stationary or moving) or on the surface of the ground or water (as in a buoy), or a buoyant aerostat, providing, in addition to tensile and optionally torsional strength:

Power, control and/or data transmission capability, using singly or severally:

1. Electrical conductors which may be made of Metals, Conductive polymers, or Carbon nanotube composites (for extremely high strength-to-weight and conduction)

2. Optical fibers

3. Fibers fed through tether which can act as tensile lines for direct mechanical control of craft attitude; craft aerodynamic control surfaces; articulation for aerodynamic shape change, gripping or releasing of material or payload; propulsion; gas valve control; or latching or other mechanical actuation

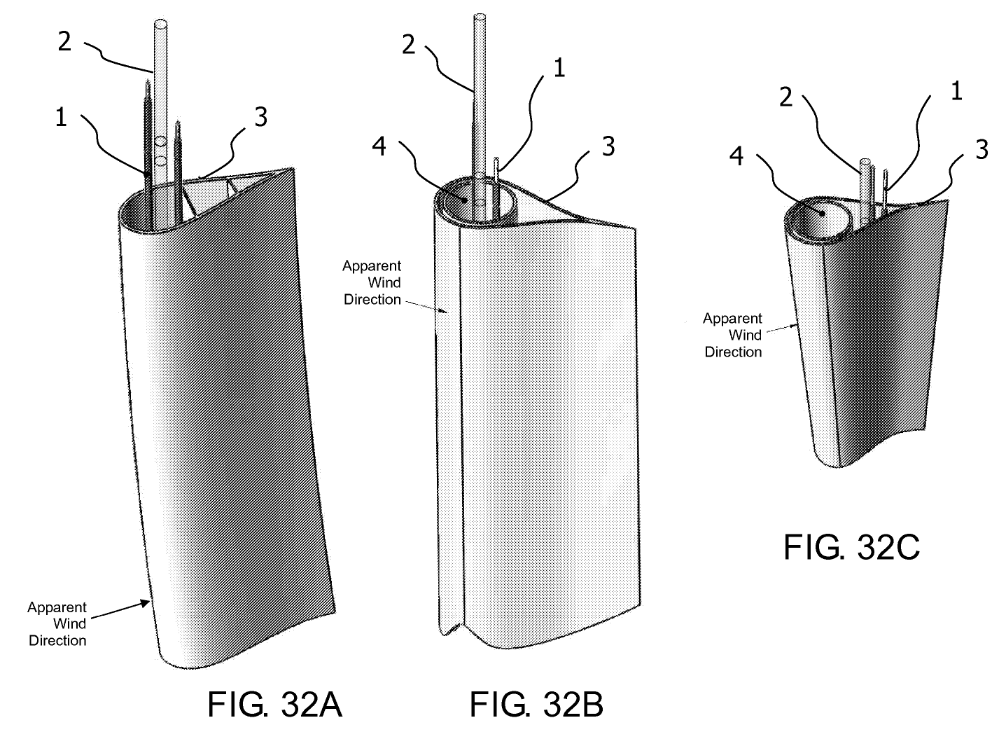

Any of these fibers or conductors may comprise or augment said tether's tensile strength, and said fibers or conductors, along with optional structural fibers may be integrated into the structure of the tether so as to be bound together by matrix into a composite cord or bound together by matrix into a composite tube or multi-channel tube. They may be passed down the center of flow channels (FIGS. 32a-c), where they would also prevent choking of flow when wound or kinked, or passed through aerodynamic fairing of section but outside flow tube, and/or passed along the outside of the tether with periodic loops or other restraints. Said fibers or conductors may be helically-wound so as to improve torque transmitted along it.

One, two or more flow channels to permit fluid to pass to and/or from base station to air vehicle in order to enable one or more of the following capabilities:

To fill or empty any buoyancy chamber(s) with lighter-than-air gas and manage pressure therein

To carry fine powdered material to craft in gas flow (fire retardant, insecticide)

To carry samples or waste to base in return flow of gas

To supply liquid or gaseous fuel to the craft

To carry other liquid, gas or mixture to or from craft

Said tether may be shaped so as to reduce aerodynamic drag with flow passage(s) integrated into aerodynamically shaped tube or alternatively, by adding fairing added to essentially circular cross-section tube; fairing may be fixed to the tribe or free to swivel around tube so as to orient itself to the apparent wind. Tether cross-section may also be shaped as an airfoil or the like, or wing-like shapes may be added periodically along length of tether so as to generate aerodynamic lift to fully or partially support the tether weight using apparent wind.

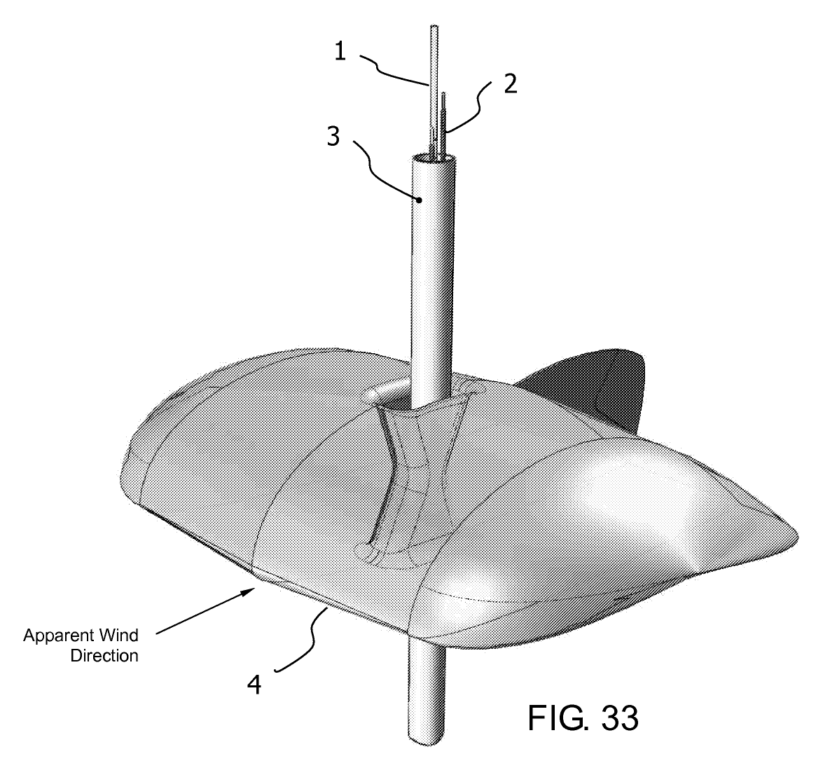

Weight of said tether may also be fully or partially supported if its cross-section is made sufficient for full or partial buoyancy when filled with lighter-than-air gas, or if buoyancy volumes (FIG. 33) are added periodically along the tether length. Such volumes may be streamlined so as to reduce drag, or shaped so as to use aerodynamic lift to assist buoyancy.

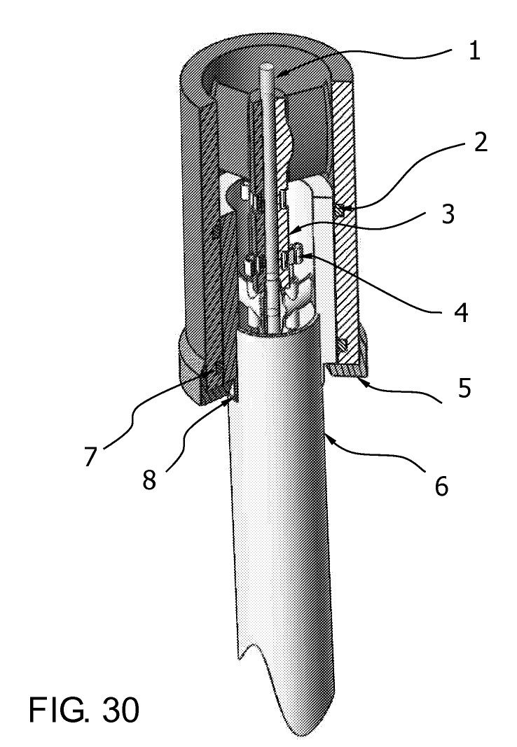

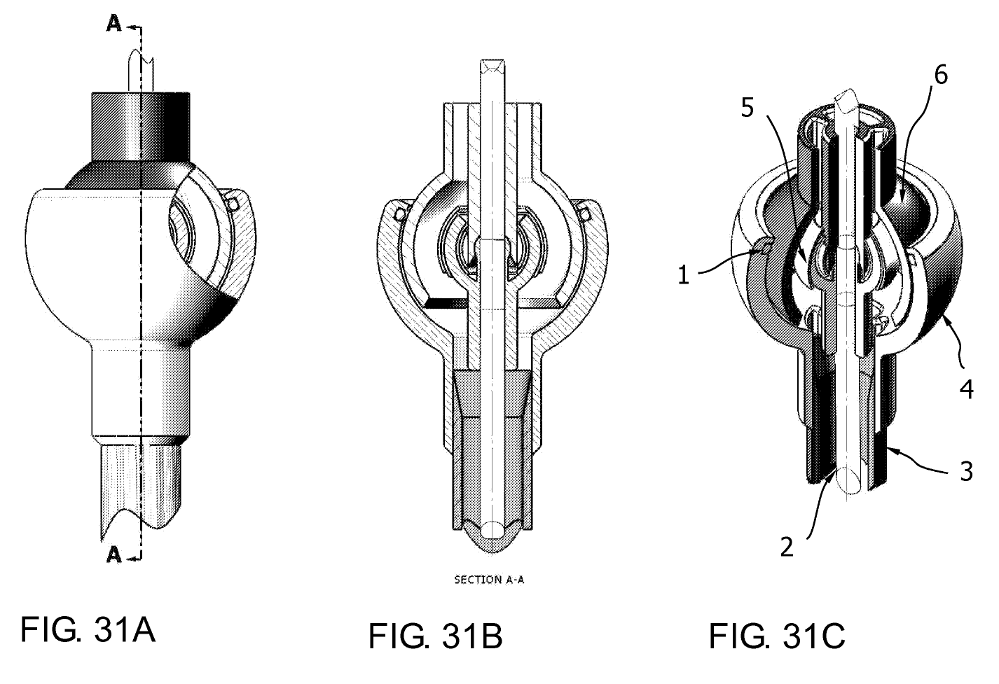

Said tether may be connected to aircraft by means of a rotational (swivel) joint (FIG. 30) to prevent twisting of tether; or a spherical joint (FIG. 31) to prevent twisting, kinking and/or wear to tether, optionally including spring return to center or other preferred position. An elastomer sheath can seal fluid in joint and foreign material out while providing return-to-center force and reducing or eliminating tensile loading on the rest of the joint; if one end is mounted to a collar with a rotating contact seal, joint can still allow unlimited rotation.

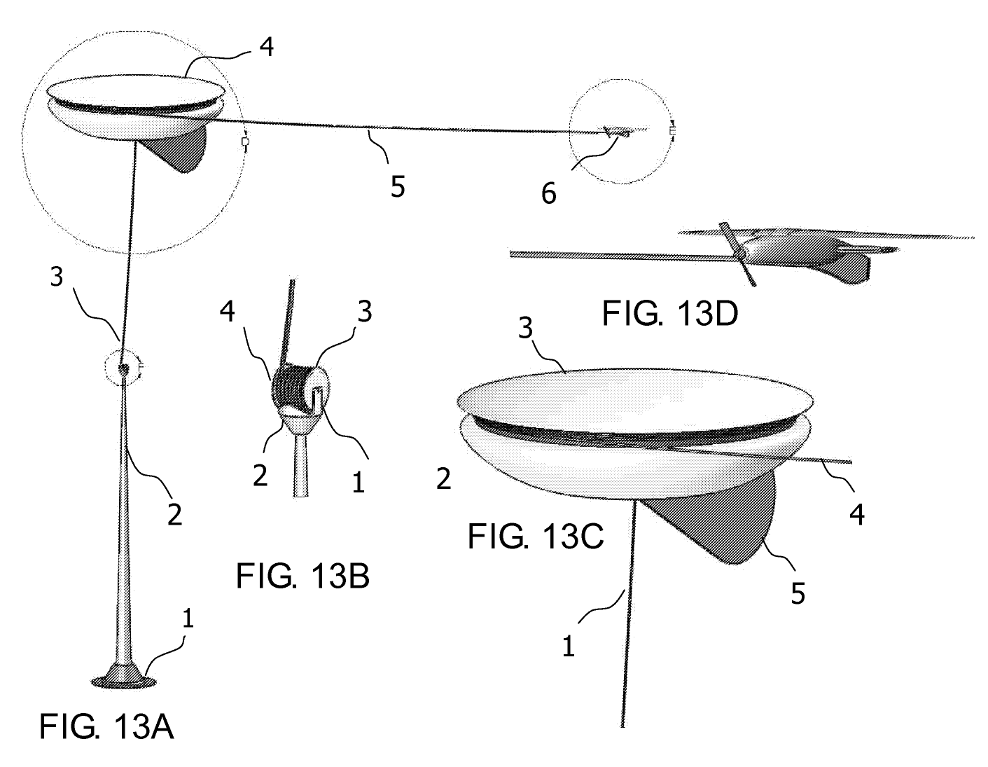

Said tether may also be connected to aircraft (FIG. 13d) be means of a swinging arc structure (FIG. 13a) with a surface or mast mount point able to travel on it so as to maintain the center of tether pull force close to the center of the aircraft. The aircraft can optionally detach from said tether; buoyant volume on the end of tether maintains it aloft for re-docking. Said tether may be retracted by spooling into helical grooves on drum shaped so as to not force flattening of flow channels during winding. Alternatively, a traction drive such as three or more flat, or two or more concavely shaped friction belts arrayed around the tether could retract it without flattening and the retracted tether collected as by coiling loosely inside a container. An aerostat (FIG. 13c) for aircraft to be tethered to may have spool shape to allow tether to wrap around it by rotating aerostat and/or aircraft's flying around it; with sufficient spooling circumference, each circuit's take-up would craft to spiral out or in, depending on direction, generating a desired search or scan flight pattern. Said tether may be elastic and made to change length with internal gas pressure if bi-directionally wound helically with fibers; at a greater than critical helical angle tether will shorten with increased pressure, at a lesser angle, lengthen.

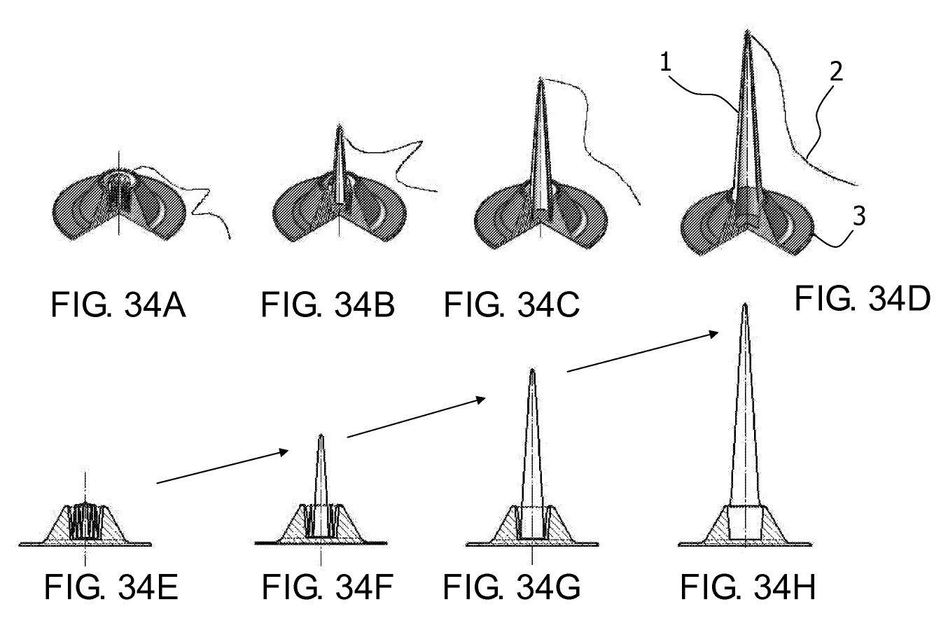

Said mast (FIG. 13a Item 2), mounted on the surface or said base station provides an attachment point for said tether (FIG. 13a Item 3) with sufficient altitude to clear local obstructions. The mast may be inflatable (FIG. 34a-h) so as to be lightweight, deployed by inflating as part of a total automated system, optionally use pressurized gas available for buoyancy, stowable in a compact space, and flexible to absorb shock. Taper from base down toward tip can optimizes strength at each point, aiding stowage, which may be by fan-folding, (where elastomer pre-shaping or elastic tensile fibers periodically along height could discipline folding), or rolling up. When deploying, said mast can pull tether so as to propel liftoff of aircraft by its simple vertical expansion; or with top bent over to ground, propel by create a circular motion at the tip to whip-launch the craft or comprise other catapult or sling mechanism. For lateral strength and stability, said mast may have some lines, three or more tubes so as to form a platform, a streamlined shape and the ability to face into the apparent wind, especially for deployment on a moving vehicle.

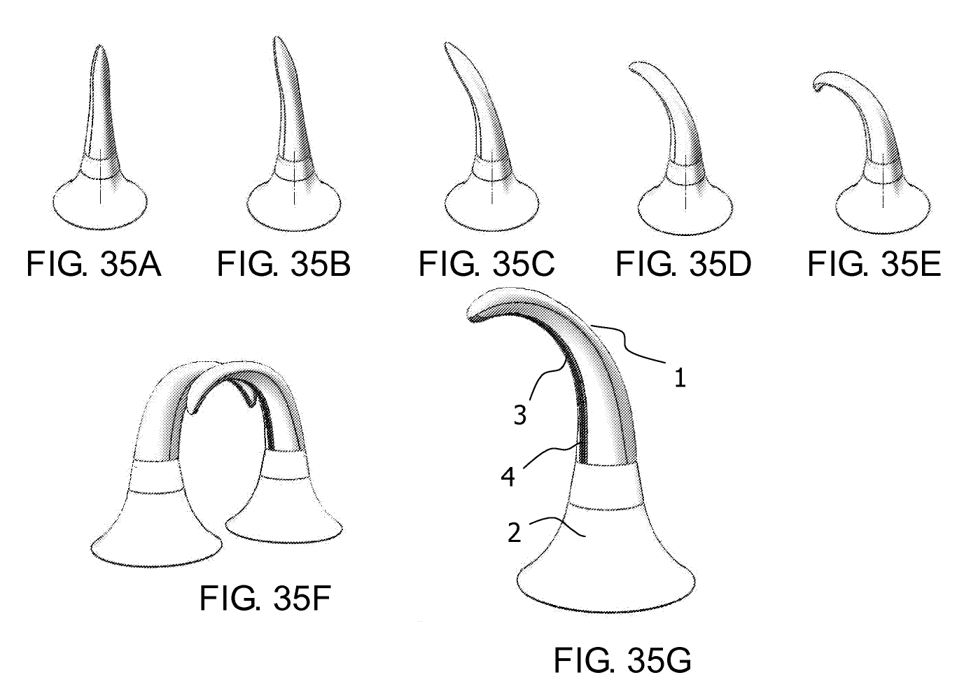

Said tethered craft can land in water near a victim, partially inflated, and act as a rescue floatation aid for a victim. Craft may also enable rescuers to reel in and recover victim gripping the craft, using a special strap restraint applied by victim, or by using actuated gripper(s) or hook(s) (FIGS. 35a-g) to hold to weak or unconscious victim and/or other object. The craft can also deliver survival supplies to an inaccessible victim, e.g., on a cliff ledge or high-rise building. Said aircraft can have one- or two-way radio link to base station so as to allow rescuers to communicate with victims.

Said actuated grippers may be used for holding to, picking up, carrying, or dropping off victims, supplies, visible or electronic beacon or marker, or other objects. Said grippers can be constructed as elastomer tubes which may be stowed inside out, rolled or fan-folded; extended by gas pressure; and reinforced longitudinally along one side with fibers so that when full extension is reached, pressure induces curl to wrap around and grip object. High friction inner surface and/or suction pads aid grip. Circumferential reinforcement will allow higher actuating pressure & grip without undue expansion or failure. Two or more grippers on multiple craft can grab a victim or object from different side, and said grippers can have “hook & fastener” connectors to be automatically or victim-secured.

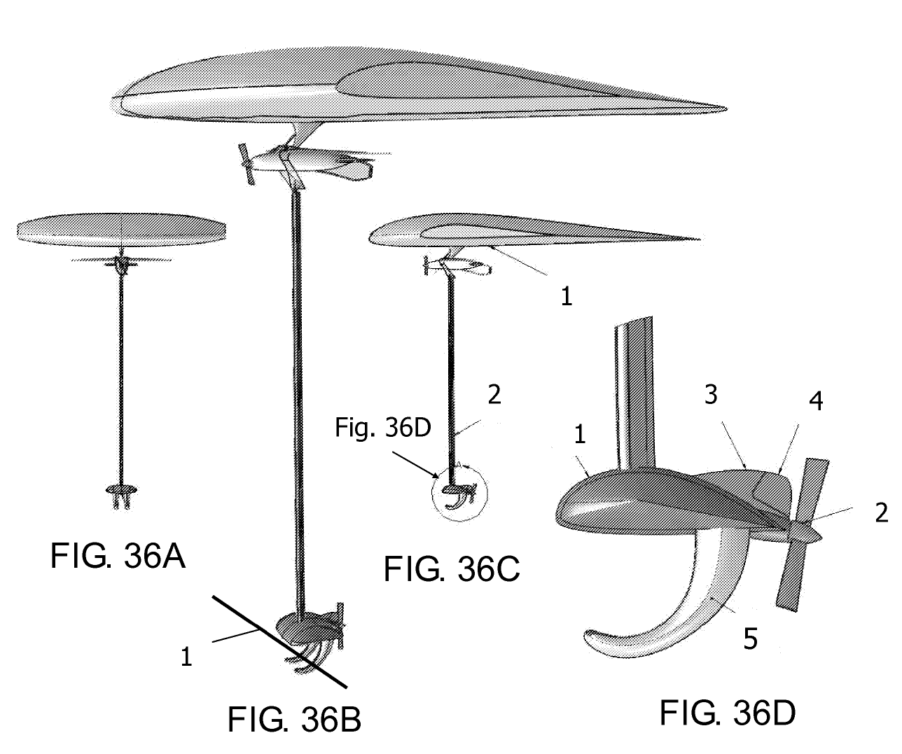

Said grippers can also be used for catching onto larger or smaller aircraft or for aircraft to catch onto stationary object(s) for landing or perching purposes, or for docking of one aircraft with another. The grippers may open to present large target, close quickly on impact, and open or react to release. Flexibility and/or friction from squeezing absorbs kinetic energy of the aircraft. Said grippers may also be used for catching onto existing current-carrying wire (e.g., power lines) for power scavenging by inductive coupling (FIG. 36b). They may make single or multiple complete circuits around a wire for better inductive coupling, providing gripper(s) extend and curl sufficiently to make a complete loop around the wire, conductive filament(s) are mounted longitudinally in the gripper (which may also serve as the tensile fibers), and one or more electrical contacts at the tip of the gripper match one or more where the fully-curled gripper meets the base and wired to the filaments such that each loop connects in series with the prior loop when contact is made. There may be guides to ensure that the end of the gripper meets the base in the correct position for the contacts to make. There may be two such grippers which wrap around a wire in opposite directions and make electrical contact with each other as above.

For any of these functions, one or more of said gripper (FIG. 36d-5) may be mounted to a pendant (36d-1) which is suspended by said tether (36c-2) from said aircraft (36c-1). A fin (36d-3) may be added to enable pendant to point itself into the apparent wind, while a rudder (36d-4) would provide more directional control. A driven propeller (36d-2) would enable further positional and directional control of the pendant, especially for near stationary operations and where there is prevailing wind to overcome.

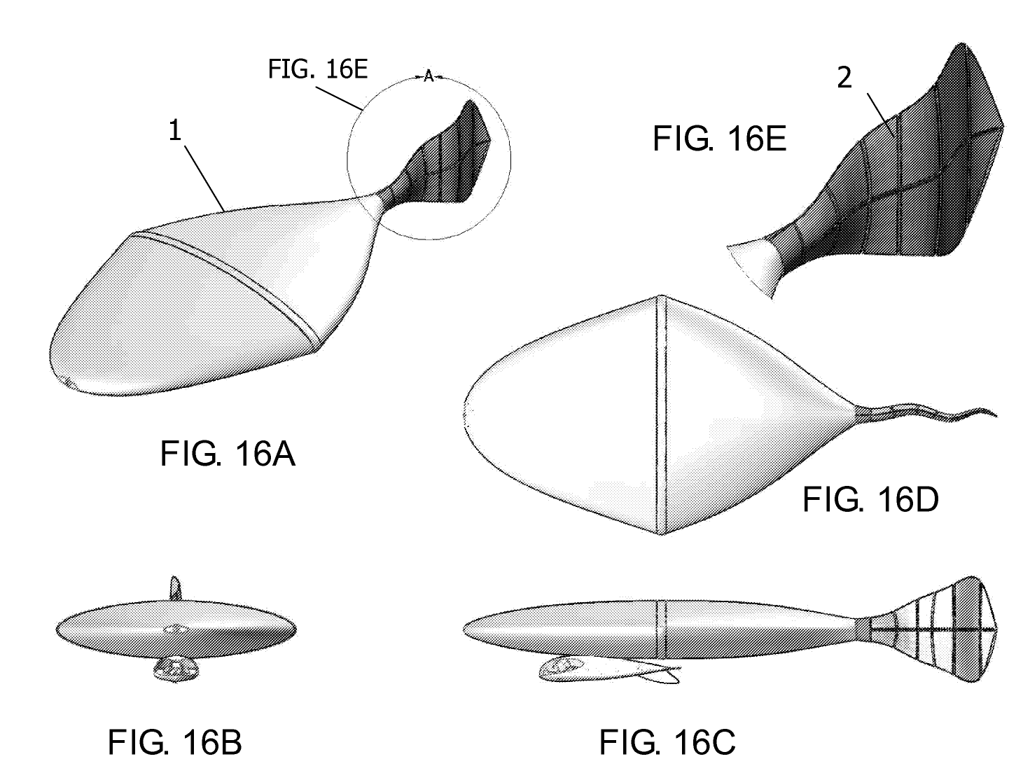

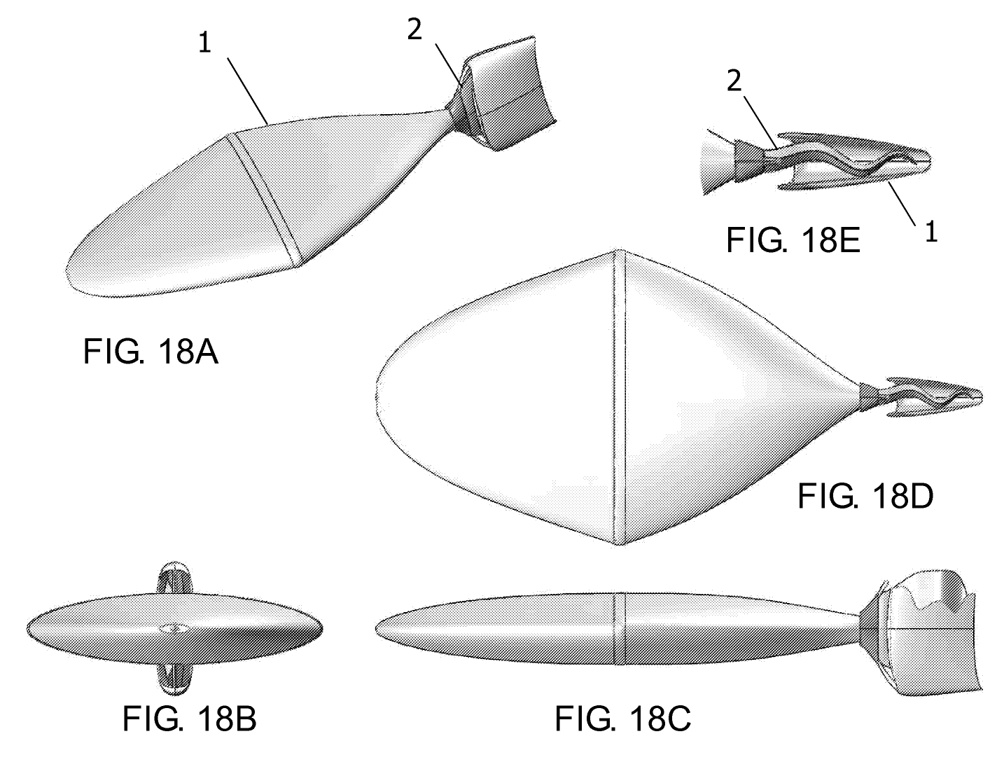

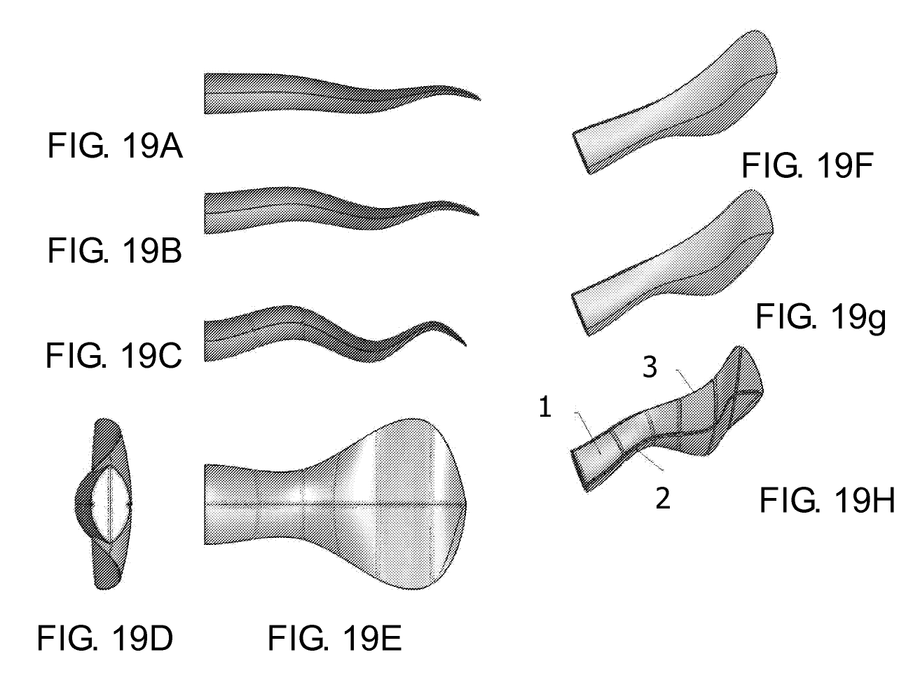

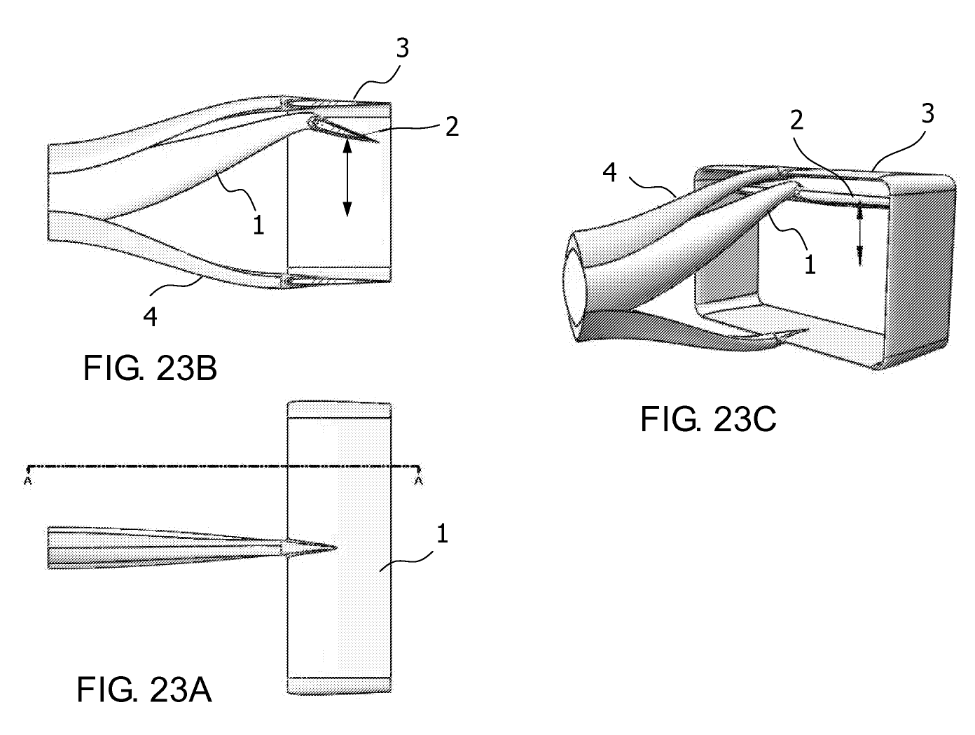

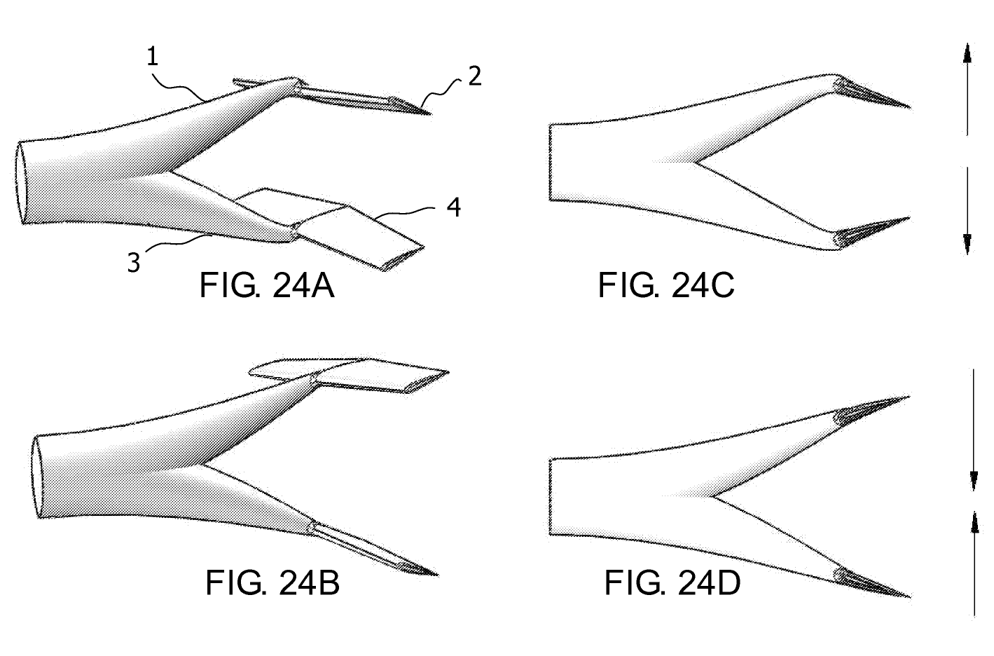

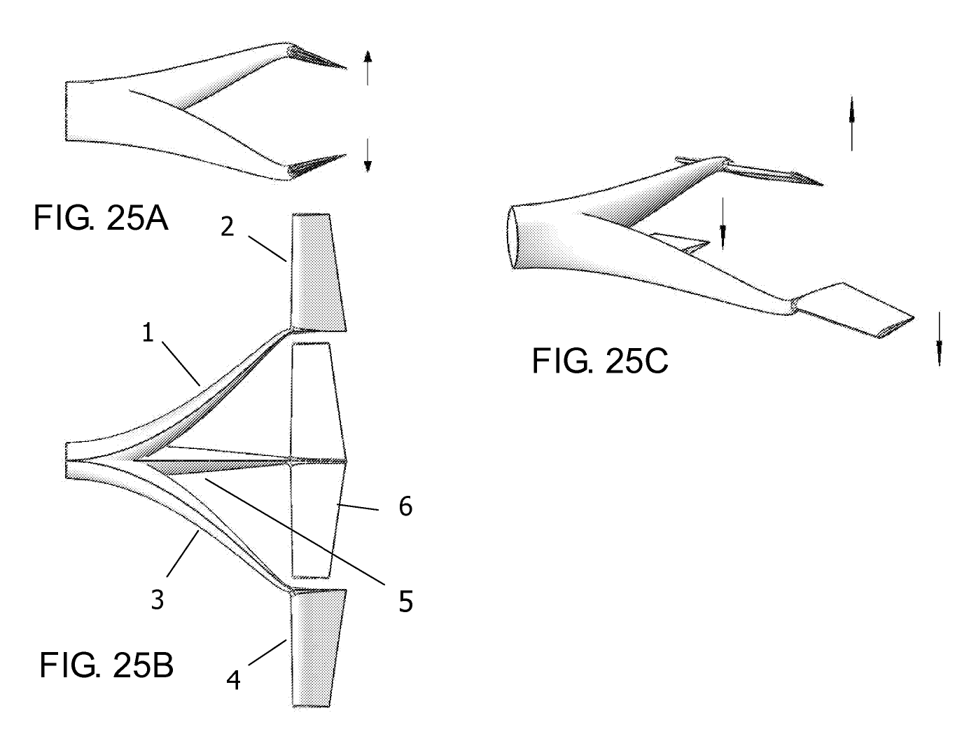

Said air vehicle may be propelled by a variety of types of bio-inspired motion (FIGS. 16-25). The current embodiment favors fluke/fin oscillation which comprises motion or aerodynamic surfaces substantially perpendicular to direction of travel while tilting surfaces in opposite sense during the up and down (or left-right) strokes so as top produce thrust. Camber direction of airfoil or like cross-section may be changed, increasing convexity opposite the direction of stroke to further airfoil performance. Said oscillating motion may be countered by opposite-directional motion of additional surfaces for cancellation of perpendicular forces (FIGS. 24-25). Additional surfaces may oppose with or without squeeze effect or a membrane between (FIG. 23b). Wriggling or slithering (FIG. 19a-h) waves of motion travel aft by sequential flexing of segments. Flukes/Fins may be enclosed with empennage, duct, shroud or nacelle (FIGS. 18, 23) for aerodynamic improvement and/or damage prevention.

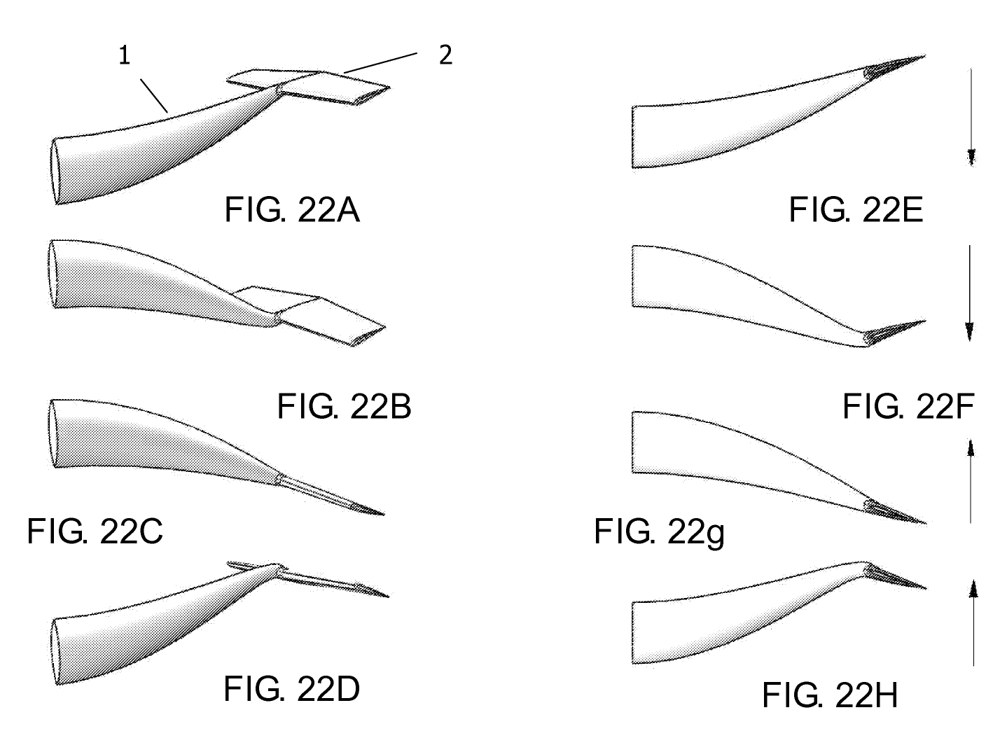

Said air vehicle may be propelled by flapping of main fluke lift surfaces (FIGS. 22-25) or one or more conventional variable-geometry propellers, using any of the methods described for variable-geometry wings, which can change one or more of diameter, pitch, blade chord or air-foil form. Oscillating motions (FIGS. 19-21) can be biased or adjusted so to create directional control or assist with thrust vectoring or curving or directional bias allowing propulsion surfaces to act as control surfaces. Said propulsion module may be flexibly connected so as to separate net mechanical motion of propulsion module from other parts of the craft, which connection may optionally serve as a joint for directional control as well. Said oscillation or slithering may be accomplished by conventional varying of gas pressure in chambers on opposing sides of a central spine (as demonstrated in prior art robotic fish), causing each segment to flex in time, or by conventional off-center tensile fiber on opposing sides of a central spine or pressurized chamber pulled in alternating fashion.

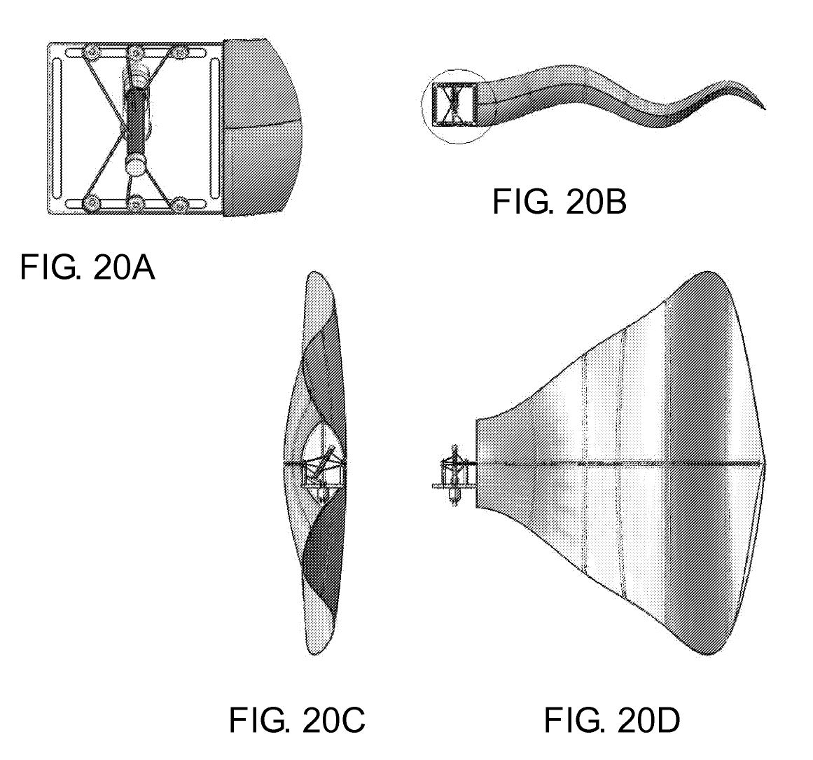

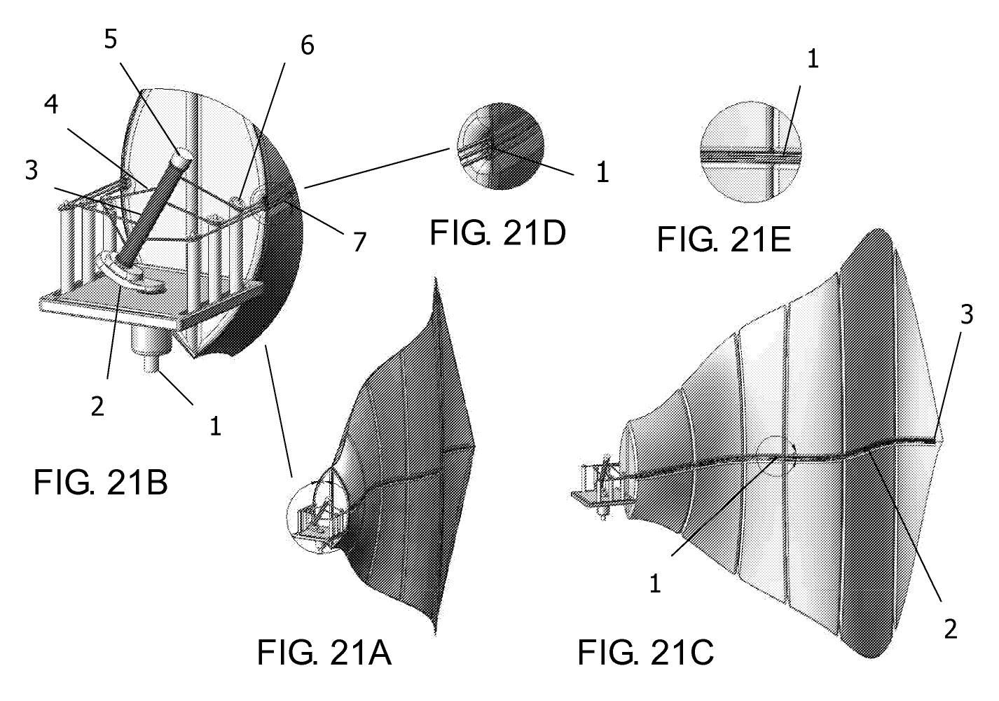

Said oscillation or slithering may also be driven by mechanisms such as a conventional rotary crank with or without variable stroke and/or phase, a crank-driven lever, a conventional multi-phase oscillating heat engine (e.g., series Stirling), or a novel variable-stroke crank with cords to transfer motion to fish-like (FIGS. 20a-d and 21a-e). Here, a mainshaft (FIG. 21b Item 1) is driven by a motor, engine or other rotary power source (not shown). On said shaft is mounted a crank arm (Item 2) that has a shaft (Item 3) mounted to it and angled such that its axis crosses the mainshaft's axis. Tensile cords (Item 4), run along the side of the fishtail (FIG. 21c) to cause its oscillations, are attached to a sheath (FIG. 21b Item 8) which allows the shaft (FIG. 21b Item 5) to rotate freely inside it without winding up said cords, which are pulled and released in an approximately sinusoidal motion. Cords attached near one end of said sheath will have a larger stroke; nearer the center, an infinitely variable lesser stroke; beyond the center, an increasing stroke but opposite in sense to that of the opposing end. Pulleys (FIG. 21b Item 7) are arrayed about the mainshaft axis, their angular position determining the phase timing of the cord wrapped around them and thereby directed into the elastomer sheath (FIG. 21d) which may have interior lubrication to allow cords to move inside it. The other ends of said tensile cords are affixed to the skin of the fishtail at longitudinal points (FIG. 21c Items 1-3) appropriate to cause the oscillation phase timing of each cord to induce the desired fishtail motion.

One embodiment of isothermal re-compression and/or expansion of said buoyancy gas by means of heat transfer fins in a cylinder is illustrated in FIGS. 29a-c. Piston (29c-3) oscillates axially within a cylinder (29c-6) driven by a rod (29c-4) connected to a crank (not shown). Steep triangular fins (29c-1,2) on said piston are matched by fins on the inside of the cylinder head (29c-1) such that there is little remaining volume at top dead center (29a-2) allowing a high compression ratio. Said fins remain in close thermal contact with the said gas allowing rapid heat transfer to maintain gas temperature near constant during compression and decompression. External heat transfer fins or fluid passages on the cylinder head (29c-5) and piston (29c-5) provide heat transfer to and/or from the surroundings or a heat transfer fluid.

Isothermal re-compression of said buoyancy gas by means of heat transfer fins and/or matrix in compression chamber drawing heat from compressing gas will reduce temperature rise of gas and reduce energy required to compress gas. Compression energy can be recovered during expansion of gas by positive-displacement volume decompression (using same volume as for compression) or by turbine. Buoyant gas in bulk volumes will be compressed and stored in conventional higher-pressure-capable volumes, to include structural actuating tubular frame or spars. Gas management will failsafe to buoyant configuration using conventional valves between the gas storage volume and buoyancy volume which fail open if a leak occur between spars and the bulk volume or winch failure which releases fiber tension where compression is accomplished by winching fibers. Compression power may be taken from a propulsion engine or motor. If the propulsion engine is internal combustion or other piston type, some pistons may be valved for use when needed to compress the buoyancy gas rather than power the engine.

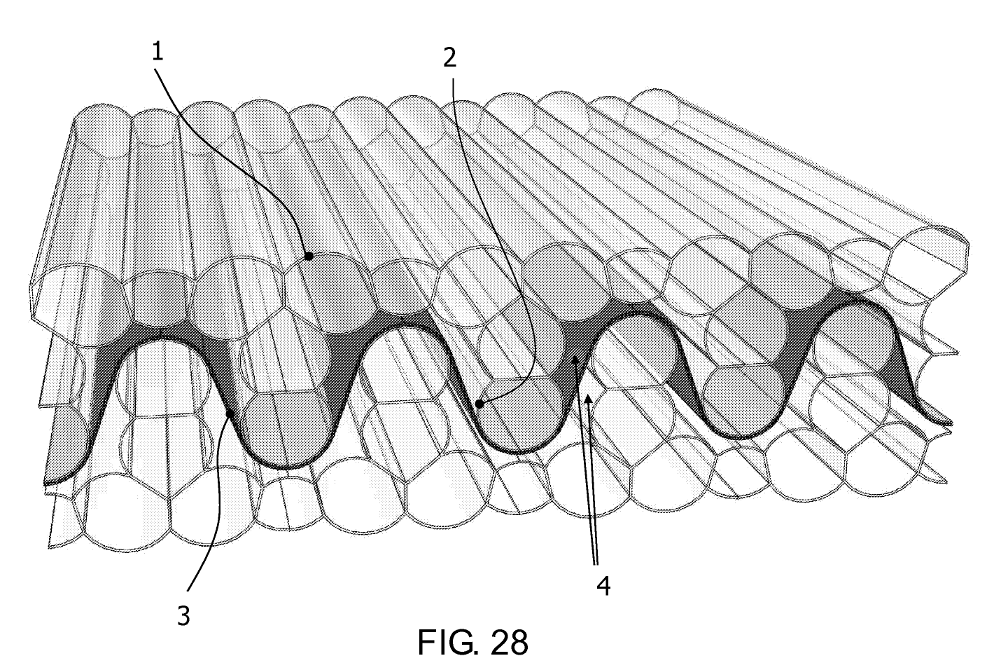

Steam may serve as said buoyant gas and may be vaporized to expand and fill buoyant volumes and condensed to contract buoyant volumes, and may further be saved for re-vaporization or discarded and replaced by water vapor condensed from atmosphere. Steam- or other warmer-gas-filled buoyant volume may be insulated by surrounding volume of other buoyant gas or air which is also heated by steam so as to reduce its density and increase its buoyancy; or by vacuum; atmospheric pressure supported by zig-zag fibers or membrane(s), in turn supported by inflated volumes (FIG. 28). Focused solar energy may be used to generate steam both for buoyancy and for a steam engine for propulsion. A condensation-type steam cycle may be run from the buoyancy steam so that propulsion power may be generated synergistically when power needed is to accelerate from a buoyant state and gain aerodynamic lift. Other buoyancy gases such as Di-hydrogen or methane may store energy and double as fuel, and may be compressed mechanically or pre-condensed cryogenically.

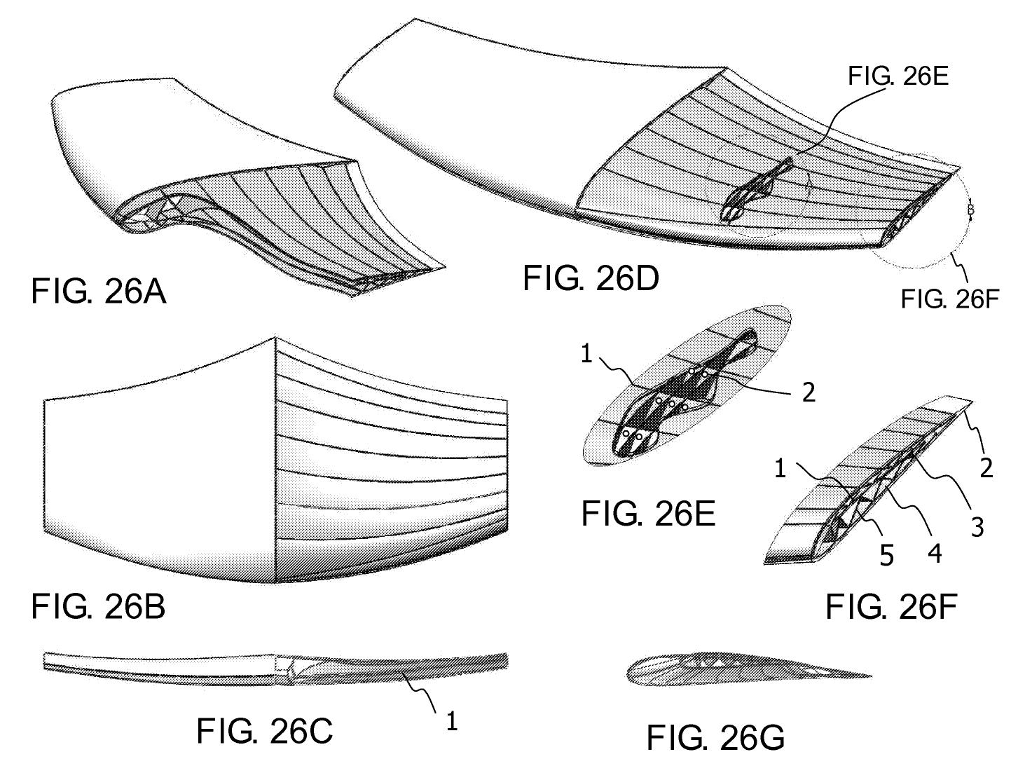

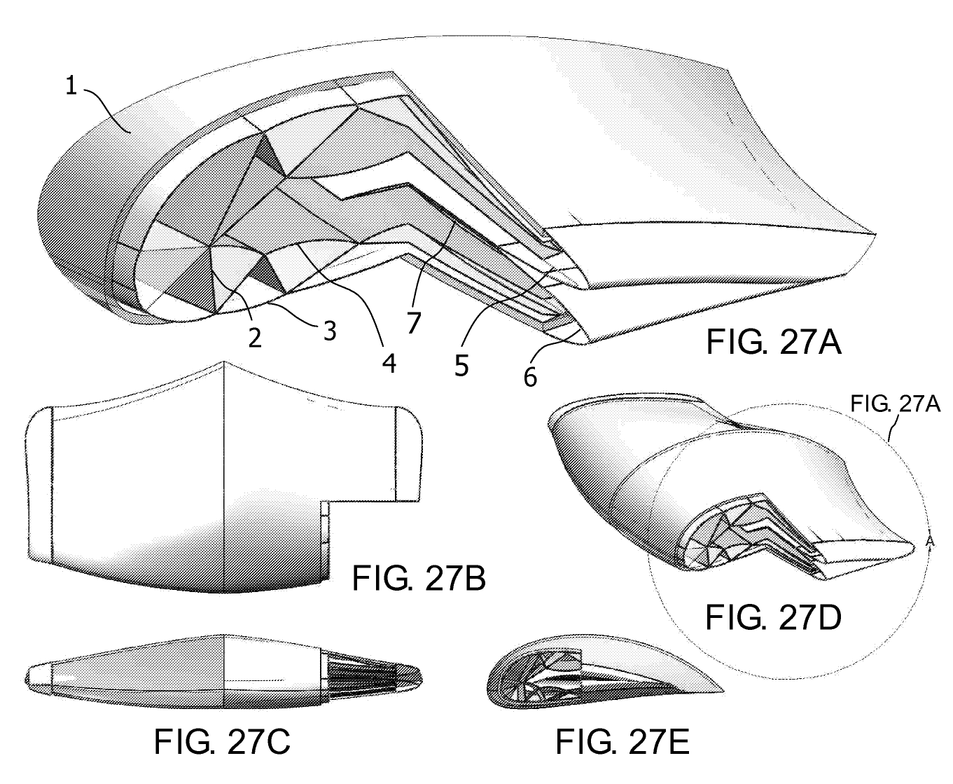

Said buoyancy gas may be contained in a multiplicity of small cells (FIGS. 26-27) for safety in the event of puncture damage. Inflation and deflation are enabled by branching artery (for inflation) and vein (for deflation) systems reaching each cell with one-way valves at cells and/or between branch points to limit deflation in the event of cell puncture. Cell-to-cell one-way valves allow only upstream cells to deflate in the event of cell puncture; for intentional deflation gas exits from cells furthest downstream. Cell-to-cell feeding pattern may be chosen so as to provide residual structure in spite of puncture and cell-to-cell and artery/vein feeding may be combined.

For shark-like patrol, the novel propulsion module (FIG. 16-25) maintains relaxed flexibility so that engine power is conventionally clutched to generate wave-like oscillations along the full length of articulated module segments with amplitude and frequency that optimize low-speed maneuverability. For operations requiring moderately higher speed and thrust, the propulsion module spine and/or segments are variably pressurized to force the locus of oscillation aft so that primarily the rear-most segment(s) of the spine oscillate/flutter at maximum speeds. At the vehicle's highest speeds, the module mimics the dash mode of fish such as tuna and pike whose caudal oscillation is principally the aft-most tail fin/fluke segment fluttering at high frequency. The morphing of the propulsion module generally consists of extending and stiffening of its spinal beam and/or articulated segments pressurization, corresponding changes in the rate of engine power-actuated oscillation, and variations in final tail section sweep and aspect ratio through conventional tail tip lines and pulleys.

The propulsion module spinal structure may be comprised of conventional hollow flexible telescoping segments that dynamically extend and retract the assembly of propulsion segments, and stiffens according to mechanical and pneumatic forces to vary the propulsion module locus of oscillation. Alternatively, the propulsion assembly may comprise a conventional spinal ribbon of flexible high strength materials such as shape memory polymers and alloys or durable composite fabric supporting reciprocating chemical muscle actuators. The buoyant propulsion segments may additionally be serially attached by conventional connectors to each other at their upper and lower extremities to dampen oscillation vibrations and to reduce dynamic propulsion stress on the spinal structure and vehicle airframe. The locus of propulsion is centerline-focused and may be conventionally gimbaled 90 degrees vertically and laterally to enable precise 360 degrees of thrust vector directional control, employing a conventional transmission air bridge to prevent conduction of oscillation forces forward to the payload module.

Materials for building and operating the present invention are lift gas and conventional envelope material variants that enclose the lift gas large cell structure while maintaining high R-factor insulation for the steam/hydrogen expansion layers. In addition to buoyant vehicle manufacturers, options for materials suppliers include the various companies that manufacture inflatable structures, such as truck-deployable shelters built for disaster contingencies and for the military—in addition to manufacturers of conventional inflatable aircraft. The primary present invention innovations in materials are the application of lift gas-fillable large cell segments combined with lightweight insulated steam/hydrogen chambers. Conformal large cell segments (similar to valved isothermal mattresses) are integrated into each vehicle module with valves connecting them to the skeletal gas management system.

When preparing for takeoff of a vehicle that has been folded for storage or transport, the user enables the expansion of the lift module, relaxing the lift module air beams to allow inflation of the module to expand and be filled through two-way valves with a combination of lift gases. The core segments comprise lift gas from the closed skeletal gas management system optionally retained on board the vehicle with periodic top-off as needed. The lift module may receive steam/hydrogen from the inflation port, variably connected to an engine bleed valve or to an external ground steam/hydrogen source. Each expansion level cellular structure nests conventionally within the next lower level, so that a completely compressed expansion module morphs down into a streamlined aerodynamic stingray blended body shape nearly flush with the core lift gas lift module level.

During the transition to level flight the cellular segments within the lift module gradually compress in proportion to air beam pressure and increasing airspeed-generated dynamic forces, continually retaining an aerodynamic lifting body shape, whether compressed or relaxed. Simultaneously, inside the vehicle structure, the skeletal air beam system pressurizes and expands telescopically, causing the pressure to increase or decrease inside the lift module segments causing each wing leading edge to become more or less rigid and causing variable extension and/or sweep of the wings.

In the buoyant lift-assisted wing lift takeoff phase, the required buoyant lift gas volume is a function of the desired up-glide angle of ascent and dynamic wing lift available. Departing contact with the surface and clear of obstacles initiates readiness for morphing. During transition to climbing dynamic lift flight, the user employs aerodynamic and mechanical air beam forces to progressively compress the lift module down to a more aerodynamic shape, thereby increasing pneumatic pressure in the wing segments. A significant portion of the onboard lift gas may be contained within the core hull layers and closed skeletal spine and spar system, employing the isothermal compression system (FIG. 29) to manage the gas between the spars and gas cell structure segments. This increased pneumatic pressure in the skeletal air beam members deploys the wings straighter out in the beginning of flight and swept back (depending on customized wing design) for higher airspeeds. Certain lift gases may also serve as fuel for the propulsion module.

With the resultant decrease in form drag, and increasing pneumatic pressure in the wing, the wings remain initially un-swept to maximize dynamic lift and facilitate climbing transition to cruise airspeed. Approaching cruise speed, lift module compression, aided by adiabatic gas expansion, generates maximum spar extension that in turn drives the wings back into further parasite drag-reducing swept back mode. This swing-wing shape change also allows the vehicle to accelerate to its design maximum descent speed, important to extended-range energy management flight profiles.

The generation of propulsive forces by oscillating the buoyant empennage minimizes drag while maximizing centerline thrust and lift. When the present invention user desires to maneuver between obstacles such as trees or buildings, such as shortly after takeoff from a high-rise office building rooftop platform, the user will typically fly slowly, allowing for reaction time to maneuver clear of nearby buildings, traffic, or other obstacles. The user will therefore maintain the present invention in loose-spine mode to allow for greater slow flight directional control. With the aircraft clear of obstacles and increasing in speed, the user will mimic aquatic animal spine stiffening to shift the locus of oscillation aft, principally to the rear-most tail segment, accelerating to a significantly higher oscillations per minute.

The present invention mimics buoyant aquatic animal body and tail motion to optimize propulsive motion per unit of expended energy. Partially compensating for the tremendous differences in operating environment for aquatic animals and aircraft, particularly between air and water density respectively, the shrouded tailfin/fluke magnifies the advantageous effects of fin/fluke shape and oscillation frequency and amplitude. In addition to the powerful bio-inspired aquatic animal-like and bird-like burst of dispersed turbulent airflow during takeoff, fish/cetacean-motion propulsion efficiency is attained during cruise by maintaining boundary layer attachment over a much longer portion of the propulsive structure—unlike airplane wings and propellers where early boundary layer separation causes turbulent wake and vortices resulting in loss of efficiency in lift and propulsion.

Additionally, the present invention's shrouded (FIGS. 18, 23) tailfin/fluke propulsion mimics the bio-inspired principles employed by aquatic jet swimmers such as squid and octopus and by conventional turbine and ducted fan engine nacelles to enhance propulsion. The present invention emulates conventional propeller or turbine shroud or nacelle retention of propulsion force of the air that is expelled from the trailing edges and tips of propellers and turbine blades, creating a greater concentration of propulsive force. Retaining and compressing the tailfin/fluke thrust-force, especially at high oscillation frequency and amplitude, creates an augmented bio-inspired pulse jet-like force that in turn creates greater efficiencies of expended energy and propulsion.

Altitude and Directional Control: another function in the propulsion module is to provide climb/descend and roll and pitch-axis directional control. Most areas of the present invention that incorporate lifting gases comprise segments of gas-impregnated large cell structure of varying cell sizes and thickness. Parallel non-structural nesting segments in each level of the lift module expand or compress. In the core level of the lift module, each segment of buoyant gas large cell structure can independently morph due to mechanical compression effected by isothermal compression (FIG. 29) of the gas into the air beam spar system (FIGS. 14-15). In the event of a loss of power or flight control in some way, the reverse of lift module compression relaxes to fail-safe buoyant expanded state and conventionally managed (as with legacy airships) for altitude control. As the user may require, the upper or lower lift module expansion layers are positively inflated for further climb/descend control, either by isothermal compression or vented/solar heated air or by releasing adiabatically expanded excess lift gas volume from the spar system.

In addition to above mentioned directional control from differential propulsion module oscillation in the dorsal plane by stiffening or relaxing one side or the other to give a directional (yaw) pull depending on degrees of differential empennage and/or tailfin/fluke deflection relative to the centerline, shrouded embodiments have conventional vector control actuation for yaw and pitch inputs. Therefore, vehicle directional control can derive from both lift module and propulsion module morphing.

The same principles apply to pitch control. Present invention propulsion module frequency and amplitude of oscillations generate pitch and climb/descend vectors, particular when oscillating in the ventral plane. Similarly, conventionally warping the wing trailing edge segments on both sides simultaneously or alternately will generate pitch or roll inputs.

Likewise, changes in present invention lift module wing and body shapes will generate auxiliary speed control inputs. For example, relaxing both sides of the wing simultaneously will act as an air brake while increasing buoyant lift.

The present invention, in scaled embodiments, may be used as follows: Civil roles—private and commercial passenger transport, cargo transport, promotional, camera, sightseeing, leisure and high adventure/extreme sports, sky lab, survey, ambulance, private and commercial fishing, agricultural spraying, utility line management, and ranching; Government roles—law enforcement, customs and immigration, area control, search and rescue, disaster relief, natural resource management; Paramilitary roles—Coast Guard, fishery protection/anti-piracy, counter-terrorism, sovereignty enforcement; Military roles—Airborne Early Warning (AEW), Anti-Submarine Warfare (ASW), Mine Countermeasures (MCM), Command, Control, Communications and Information (C3I), and Reconnaissance, Intelligence, Surveillance, and Target Acquisition (RISTA).

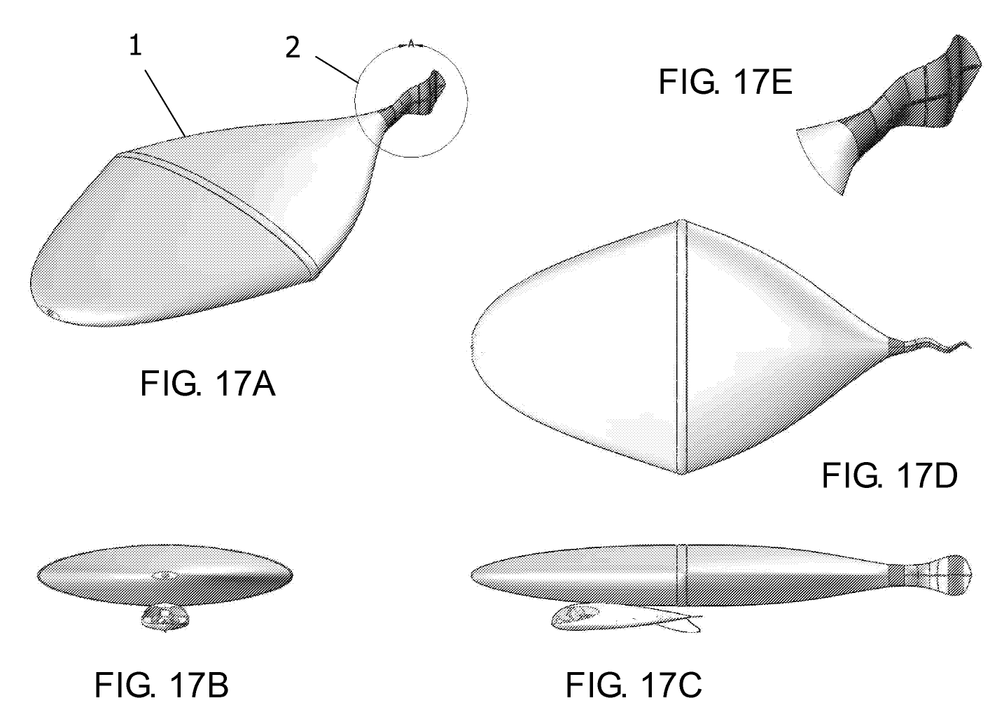

Launch: Lift of from the ground or water surface may be accomplished with a combination of buoyancy, propeller or other device used for forward propulsion. Push-Off of Ground Or Water (POGOW) launch comprises, when in contact with ground, rapid vertical expansion by inflation or elastic energy release in the rear or other section of buoyant volume, or tube which could be similar to said inflated mast (FIG. 34) mounted to craft. A rapid change of shape (FIGS. 16-17) from more horizontally oriented—e.g. a rapid transition of lift module from wide-span state to elongated-state while oriented vertically with rearmost point pushing against the ground will enable a propulsion launch. Landing may be aided by all techniques above, used in reverse to absorb kinetic energy of descent and cushion landing.

The present invention Personal Air Vehicle (PAV) embodiment (FIGS. 1-5) may be housed when partially deflated in a standard R1-zone two-car single-door garage. The PAV in pre-flight mode has adjustable buoyant lift, allowing for easy wheeled or un-wheeled ground movement of the present invention out into the driveway. An ultra-light PAV embodiment may be strapped on like a conventional backpack for ground takeoff (or airborne deployment from a jump aircraft) with the propulsion module mounted like a bicycle.

The user(s) may preload or wait until after boarding the PAV to add a compensating volume of lift gas to the lift module to achieve desired PAV buoyant lift while simultaneously engaging the propulsion module. The desired speed and angle of liftoff will determine the amount of differential lift gas inflation in relation to available dynamic lift required before surface release. For a gradual, more horizontal up-glide, the user can release almost immediately and allow the differential lift, in conjunction with dynamic propulsion, to commence the flight. For more steep vertical liftoff, as might be required in an area of obstacles (trees, tall buildings, etc.) the user can delay release until achieving optimal buoyant lift. Options for lift steam/hydrogen generation include both engine bleed air and auxiliary ground power units.

Liftoff, Climb and Transition to Cruise: The aerodynamic lifting body shape of the PAV, combined with lift-generating extended wings and propulsion module buoyant lift, augment the buoyant lift component for climb and upward pitch angle as soon as the propulsion module is generating thrust. Upon up-gliding clear of obstacles, a decrease in pitch angle permits speed over the ground and rate of climb increases in exchange for reduced angle of climb to altitude. Deploying the air beam skeletal system (FIGS. 14-15) to compress the lift module expansion layers has the following main effects:
reduces aerodynamic drag, thereby
increasing dynamic lift effectiveness and
increasing airspeed;
reduces lift gas volume and thereby total buoyant lift;
increases pneumatic pressure in the lift module envelope and spar system, thereby
increasing wing and spar rigidity, thereby
further deploying the wings and
tightening the spine, thereby
moving aft-ward the locus of propulsion module oscillation, thereby
enabling higher tailfin/fluke oscillation frequency.

Variable effective compression the lift module can involve combinations of:
mechanically pressuring the skeletal air beam system
isothermal repressurization of lift gas from the core lift segment back into its skeletal system
cooling heated lift gas and
dumping overboard or reconstituting non-helium lift augmentation agents.

Cruise: throughout the morphing process, the vehicle remains maneuverable by means of both the conventionally gimbaled propulsion system and differential wing shaping. Top cruise speed is achieved by optimizing the locus and plane of oscillation for the propulsion module, in conjunction with optimal oscillation frequency, deflection/heave amplitude, and aspect ratio of the optimized tail. Directional control, mostly for course corrections and altitude management, requires very small yaw/roll-inducing deflection or wing shape changes in the lift and/or propulsion modules. During cruise flight, small wing shape changes, coordinated with propulsion module deflection shifts, are the primary directional control inputs. Variable empennage and tailfin/fluke oscillation deflection and tail shape changes are the primary inputs for slow flight maneuvering, while the combination of all inputs achieves the greatest maneuverability, as with aquatic animals. Employing lift module shape changes in coordination with bio-inspired propulsion module oscillation variations approximates the maneuverability advantages that aquatic animals and birds have over submarines and airplanes respectively.

Descent and transition to landing: nearing an urban destination, e.g. office building or home rooftop platform, in high-speed descent from cruise altitude, the user progressively restores previously compressed lift gas back to nearly launch buoyant lift volume. Meanwhile, the user may also commence relaxation of the liftgas skeletal storage system or otherwise conventionally generating steam/hydrogen expansion of the lift module to not only serve as an air brake but to generate sufficient positive differential buoyant lift for the powered desired angle of vertical landing. The PAV's off-the-shelf autonomous flight control system's precision adjustment of altitude and airspeed enables vehicle operation with high in-flight safety and reliability under much lower weather ceiling, visibility, and crosswind conditions than helicopter “point in space” or Copter ILS approaches. Approaching the platform, the user adjusts buoyant lift for level off and touchdown, followed by further buoyant lift adjustments as required for ground handling.

Human powered operations: The present invention is expected to be sufficiently light and simple to operate to accommodate conventional rotary pedaling and/or hand cranking converted to oscillating motion by crank or other mechanism to drive the oscillating propulsion elements (FIGS. 16-25). Or, coupled directly to a conventional propeller or other rotary propulsion element, its buoyancy-assist and shape changing for high aerodynamic lift-to-drag ratio ensures low drag at all speeds and makes human power more practical.

The sense of safety and confidence engendered by the failsafe buoyant large cell structure panels through the vehicle, combined with the quiet economical ease of use and freedom of movement above the ground, will lead to wide acceptance of the present invention HPV embodiment throughout the developed and developing world. The HPV propulsion module may incorporate a supplemental conventional off-the-shelf lightweight nylon flywheel spring mechanical battery that can be continually recharged by in-flight pedaling motion of the user, augmented by airborne wind-powered and lightweight air turbine generators. The user will typically pre-charge the mechanical battery (wind it up) on the ground before loading. The mechanical battery will therefore have a high store of kinetic energy available for throttle engagement for take off, or in other times of increased energy demand. This burst of takeoff energy, although expended rather quickly, is sufficient to attain prompt surface separation, buoyant flight, and low level winds escape speed. At higher altitude, cruising dynamic wing lift frees up energy demand to allow gradual rebuilding of the potential energy store during the rest of the flight, effectively recharging the mechanical battery through continuously variable low gear ratio pedaling and air turbine rotation.

Cetacean (whale/dolphin/porpoise) Flight: a novel method of endurance and range-extending flying possible with the present invention that is impractical in legacy aircraft is cetacean flight, e.g., porpoising energy management flight. This super-economical energy management Porpoise Flight profile significantly increases range and endurance while expending minimal motive energy. Because the present invention normal level flight mode provides optimal cruise speed performance, the slower climb/descend Porpoise Flight will most commonly be selected only for long-distance endurance travel within uncontrolled or low traffic airspace. Advanced navigation and traffic avoidance instruments make the profile useable in nearly all controlled airspace.

Mimicking how aquatic animals harvest propulsive energy by traversing underwater pressure gradients, the present invention has the unique capacity to harvest lift energy generated by adiabatic gas volume expansion and heat from solar exposure, from aerodynamic friction, and from internal/external combustion or turbine engines. Employing hybrid heating of the onboard buoyant lift gases (helium, air, and steam/hydrogen) to generate buoyant lift into higher flight levels and airstreams (as do world-circling balloons), the present invention optimizes in-flight energy and directional control by combining latent/static lift with dynamic engine-generated lift. Porpoise-like up-gliding in hybrid buoyant/dynamic lift mode to pressure height flight level equilibrium, the present invention reverses vertical direction by morphing into an aerodynamic shape to enable a porpoise-like down-glide trade of altitude energy for speed and distance over the ground. This morphing is accomplished by drawing the expanded lift gas into the skeletal chambers, thereby deploying the wings to full swept extension, and by releasing steam/hydrogen and heated air. Adjusting the extended wings sweep for optimal lift per unit of drag down-glide efficiency, the present invention employs principles of soaring while enjoying the advantages of reliable buoyant lift over reliance on localized and variable thermal air columns. After optimizing the energy trade for distance allowed by the ambient conditions, the present invention reverses again to hybrid buoyant/dynamic lift mode for climb to a new equilibrium pressure height to repeat the porpoise down/up-glide profile.

The present invention minimizes conventional equilibrium pressure height flight level limitations, the maximum altitude to which airships can fly due to maximum adiabatic lift gas expansion within their rigid airframes. In addition to helium lift and dynamic wing lift, the present invention can exploit various hybridizations of other lift gases, e.g. steam/hydrogen, hot air, and ammonia. The present invention accommodates gas expansion not only as pneumatic pressure to deploy and stiffen the wings, but it can also pack lift gas into the hollow air beam spar system to a certain pressure. This pressurized lift gas serves as a ballast substitute for use during the descent and landing phases of flight, as does water condensed from steam/hydrogen and collected in an onboard reservoir or dumped as desired. The present invention may carry the minimum possible helium to maintain partial or slightly negative buoyant lift, using the hybrid lift gases to make up the difference for the required buoyant lift, with the remainder of flight lift generated dynamically. Excess lift gas in the skeletal system also serves as a source of rapid emergency backup lift for use in event of loss of dynamic lift.

The user of alternative present invention embodiments has the option of compressing the lift module gas at cruise altitude. The expansion of onboard lift gas naturally causes increases in pneumatic pressure within all three modules during climb. In addition to mechanical and aerodynamic forces, alternative embodiments typically vent lift steam/hydrogen as the main component of lift module morphing. In addition to releasing the steam/hydrogen, such embodiments allow condensation and natural cooling to reduce the effective lift while collecting moisture to the reservoir for subsequent steam/hydrogen generation. This extra water ballast is welcome and sustainable aloft due to dynamic lift to aid in altitude control. Employing lift steam/hydrogen increases the volume of required lift module expansion by approximately one third for equivalent lift, but likewise simplifies the energy-intensive task of lift gas recompression while maintaining a continual recyclable and variable source of buoyant lift. Likewise, such embodiments modify total lift by heating or cooling the lift gas directly by tapping engine heat or otherwise generating steam/hydrogen condensate.

Rooftop Mooring: In addition tethering operations (FIGS. 10-12), the present invention makes possible various conventional capture and winch-down launch and recovery methods, impossible for fixed winged aircraft, improving on the winch hook method used by helicopters to recover in difficult weather onto an aircraft carrier deck. For the present invention, a remotely controlled buoyant balloon may be signaled to release and carry upwards a lightweight hook or loop that is reeled down to the landing platform after connection with the vehicle. The lightweight tether, floating well above adjacent obstacles, may have multiple lines connected to the corners of the landing platform. Unlike the pendulum swing risks for helicopters landing with a single winch cable, the four tethers of the present invention system conventionally reel down simultaneously against positive buoyant lift to optimize landing stability.

Future Vision—Urban Traffic Conduits using still air, forced air, and vacuum channels: In urbanized areas, PAV traffic density will likely favor systems for air corridors and channels. In addition to airspace designated as virtual “highways in the sky,” transportation authorities may install large conventional transparent or opaque conduits between high-density travel nodes, e.g., in Hong Kong between the commercial district on the island and the residential areas along the hillsides, possibly anchored between two tall buildings or onto purpose-built towers. The conduits could be of sufficient size to accommodate multiple levels and directions of traffic. For much less energy and public investment than currently devoted to highways, bridges and subways for surface vehicles, a lightweight polymer (very strong but flexible and long-lasting) composite material conduit of tunnel shape and size would accommodate multiple lanes of present invention traffic on several vertical levels.

Designated for varying speeds, the conduit channels would protect air vehicles inside from the external elements such as wind, extreme temperature, and precipitation, and could accommodate conventional multi-vehicle configurations as described below. With all vehicles in the conduit capable of buoyant flight, the conduit would require relatively minimal structural load-bearing reinforcement compared to heavy wheeled traffic bearing structures. PAVs bumping against the conduit sides would generally not cause damage to the conduit or other same direction air vehicles. Gaps between channels could allow for en route change of lanes or speeds. High-speed conduit lanes could be effectively conventional wind tunnels, with streams of air boosted by conventional fans through its internal venturi shape. The volume of vehicle traffic required to justify public funds to construct and operate these energy-conserving wind or vacuum-assisted conduits would likely be much lower than comparable legacy public transportation infrastructure investments. With such conduit wind boost in the desired travel direction, present invention buoyant vehicles need only deploy a sail-fin to exploit these speed and efficiency-enhancing tailwinds.

The most advanced conduit systems will imitate conventional bank teller vacuum tube cartridge shuttle systems. Requiring more powerful conventional fans or turbines to generate a vacuum (possibly multiples or derivatives of the same fan units powering the wind assist conduits), and requiring conduit installation with tighter tolerances and air vehicle standardized dimensions or add-on seals, the system will greatly increase present invention vehicle speed for those equipped with airtight seals compatible with the vacuum conduits.

Present invention embodiments to replace barges, trains and the like: another advantage of the present invention is the possibility of multiple connected vehicle travel. Airplanes generally cannot be safely attached to each other for multi-craft air travel. However, just as multiple buoyant barges attached to each other are all navigated by the one inhabited ship on water, and rail cars are moved more economically over land when attached in train to an engine, so present invention vehicles traveling to same destinations can enjoy significant financial and labor savings by train or barge mode linked air vehicle flight. Buoyant vehicles generate even greater proportional savings than the referenced surface groups of vehicles because buoyant lift allows attachment to a high thrust vehicle that propels and navigates on behalf of all attached vehicles, saving engines, fuel, and crew costs. Likewise, multiple cargo lifters, for example, could be attached together to lift an outsized cargo that otherwise would have to be disassembled for component transport by individual lift vehicles. This linked vehicle feature allows for maximum fleet flexibility where the transport company does not need to invest in or manage payload for the mega-lifters that would be necessary to carry large single-ship loads.

Aquaatic Commercial and Recreational Uses: another present invention use with significant market potential is aquatic applications, such as boating and fishing. This includes sport and commercial deep-sea fishing, ship to shore shuttle service for oil platforms, cruise ships and remote islands, maritime patrol and rescue, or marine biologists conducting research. Instead of enduring the resistance of high waves and slow surface speed suffered by legacy watercraft, the user can employ the present invention air vehicle, it being air and water tight and able to land and takeoff on water vertically.

Developing world rural populations, where personal travel distances are greater, resources more dispersed, and airspace less dense, may prove to be first adopters of the present invention as their leap-ahead technology primary means of personal and public transportation. Advances in inexpensive and widely accessible precision air traffic avoidance and winds, temperature, and pressure aloft awareness, along with autonomous flight controls, will lead to free-flight profiles more akin to those of birds and aquatic animals. These will in turn lead to improvements in flight reliability and efficiency, thereby filling the skies at last with manned and unmanned vehicles traveling as safely as do the aquatic animals and birds in their elements. This will free both urban and rural populations from the limitations of earthbound congested roads and airports.

The hybrid dynamic/morphing shape buoyant, dynamic lift-assisted (hybrid) air vehicle, employing aquatic-like (e.g. fin) propulsion was discussed, with many variations and examples. Different material can be used for the construction of the vehicles (e.g. wood, metal, fabric, plastic, bubble sheets, rubber, string, silk, cable), and it can be used for different applications (e.g. rescue or military). Although the invention has been described herein with specific reference to a presently preferred and additional embodiments thereof, it will be appreciated by those skilled in the art that various modifications, deletions, and alterations may be made to such preferred embodiment without departing from the spirit and scope of the invention. Accordingly, it is intended that all reasonably foreseeable additions, modifications, deletions and alterations be included within the scope of the invention, as defined in the following claims.

1. A system for dynamically-shaped buoyant dynamic lift-assisted air vehicle, said system comprising:
a lift module,
a propulsion module,
and a payload module,
wherein the shape of at least one of said lift module, said propulsion module, or said payload module is dynamically changed.

2. A system as recited in claim 1, wherein said shape is morphed into another structure by the means of an on-board lift-gas management system.

3. A system as recited in claim 1, wherein said air vehicle moves into, within, over, by, or on a tunnel, conduit, pipe, wire, cable, or rail.

4. A system as recited in claim 1, wherein said propulsion module is an aquatic-like oscillating empennage propulsion system.

5. A system as recited in claim 1, wherein said system uses a gas for fuel and for lift.

6. A system as recited in claim 1, wherein said system is partially or fully solar-powered.

7. A system as recited in claim 1, wherein said system comprises a tether.

8. A system as recited in claim 7, wherein said tether connects to a power line.

9. A system as recited in claim 7, wherein said tether recharges batteries or powers said air vehicle.

10. A system as recited in claim 1, wherein said air vehicle is an unmanned vehicle

11. A system as recited in claim 1, wherein said air vehicle comprises a gas-holding skeletal structure.

12. A system as recited in claim 7, wherein said tether anchors to a static or mobile object to stabilize or synchronize the position of said air vehicle.

13. A system as recited in claim 7, wherein said tether comprises an optical fiber, cable, or communication medium.

14. A system as recited in claim 1, wherein said air vehicle comprises a flexible skin.

15. A system as recited in claim 7, wherein said tether comprises a channel, conduit, or tubing to transport material, liquid, fluid, fuel, gas, or objects from or to said air vehicle.

16. A system as recited in claim 1, wherein said air vehicle comprises a isothermal recompression system or container with one or more heated gases for lift.

17. A system as recited in claim 1, wherein said air vehicle comprises a hybrid-energy, a hybrid-propulsion, or a hybrid-lift module or subsystem.

18. A system as recited in claim 1, wherein said system comprises an inflatable mast.

19. A system as recited in claim 1, wherein said air vehicle is attached to or en-route detachable from another air vehicle.

20. A system as recited in claim 1, wherein said air vehicle comprises a gripper module.
